(19) United States
(12) Patent Application Publication
(10) Pub. No.: US 2025/0287394 A1
(43) Pub. Date: Sep. 11, 2025

(54) METHOD AND APPARATUS FOR MEASUREMENT GAP IN MOBILE WIRELESS COMMUNICATION SYSTEM

(71) Applicants: Soenghun KIM, Gyeonggi-do (KR); BLACKPIN INC., Seoul (KR)

(72) Inventor: Soenghun KIM, Gyeonggi-do (KR)

(21) Appl. No.: 19/074,605

(22) Filed: Mar. 10, 2025

(30) Foreign Application Priority Data
Mar. 11, 2024 (KR) 1020240033913

(51) Int. Cl. H04W 72/231; H04W 72/1268; H04W 72/232

(52) U.S. Cl. CPC H04W 72/231; H04W 72/1268; H04W 72/232

(57) ABSTRACT

A method and apparatus to support XR services is provided. Method for supporting XR services includes receiving from a base station, a RRCReconfiguration that includes MeasConfig and CellGroupConfig, establishing based on a specific equation and a mgta a second period, determining based on the second period a first period and a third period, and determining based on downlink signal related to measurement gap deactivation whether to perform transmission and reception on specific serving cells during the first period and the third period.

### CROSS-REFERENCE TO RELATED APPLICATION

This application claims priority to and the benefit of Korean Patent Application No. 10-2024-0033913, filed on Mar. 11, 2024, the disclosure of which is hereby incorporated herein by reference in its entirety.

### BACKGROUND

### Technical Field

The present disclosure relates to enhanced measurement gap handling for extended reality in a mobile communication system.

### Related Art

To meet the increasing demand for wireless data traffic since the commercialization of 4th generation (4G) communication systems, the 5th generation (5G) system is being developed. For the sake of high, 5G system introduced millimeter wave (mmW) frequency bands (e.g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability.

Extended Reality (XR) refers to all real-and-virtual combined environments and human-machine interactions generated by computer technology and wearables. XR is an umbrella term for different types of realities.

During a XR service, huge amount of Data Bursts may be generated and transmitted over NR downlink and uplink. Data Burst of XR services often have stringent delay budget. It requires more sophisticated uplink scheduling technique to achieve timely scheduling and to avoid excessive resource waste.

### SUMMARY

Aspects of the present disclosure are to address the problems of XR traffic handling. The method includes receiving from a base station, an RRCReconfiguration that includes MeasConfig and CellGroupConfig, establishing based on a specific equation and a mgta a second period, determining based on the second period a first period and a third period, and determining based on downlink signal related to measurement gap deactivation whether to perform transmission and reception on specific serving cells during the first period and the third period.

### BRIEF DESCRIPTION OF THE DRAWINGS

FIG. 1 is a diagram illustrating the architecture of a 5G system and a NG-RAN.

FIG. 2 is a diagram illustrating a wireless protocol architecture in a 5G system.

FIG. 3 illustrates overall operation of the UE and network.

FIG. 4 illustrates the operation of the UE regarding PLMN selection and cell selection and cell reselection.

FIG. 5 illustrates RRC connection establishment procedure.

FIG. 6 illustrates UE capability transfer procedure.

FIG. 7 illustrates RRC connection reconfiguration procedure.

FIG. 8 illustrates data transfer procedure in RRC_CONNECTED state.

FIG. 9 illustrates random access procedure.

FIG. 10 illustrates scheduling request procedure based on dedicate scheduling request resource.

FIG. 11 illustrates buffer status reporting procedure.

FIG. 12 illustrates MAC PDU format.

FIG. 13 illustrates MAC subheader format.

FIG. 14 is a diagram illustrating various formats of BSR.

FIG. 15 is a diagram illustrating a format of DSR.

FIG. 16 is a diagram illustrating various gaps.

FIG. 17 is a diagram illustrating gap patterns of various gaps.

FIG. 18 is a diagram illustrating time pattern for measurement gap deactivation.

FIG. 19 is a diagram illustrating time period associated with measurement gap.

FIG. 20 is a diagram illustrating operations of the terminal and the base station for data transfer and measurement.

FIG. 21 is a diagram illustrating operations of the terminal and the base station for measurement gap.

FIG. 22 is a diagram illustrating operations of the terminal.

FIG. 23 is a block diagram illustrating the internal structure of a UE to which the disclosure is applied.

FIG. 24 is a block diagram illustrating the configuration of a base station according to the disclosure.

### DETAILED DESCRIPTION

In the rapidly evolving landscape of wireless communication, Extended Reality (XR) applications, encompassing Augmented Reality (AR), Virtual Reality (VR), and Mixed Reality (MR), demand superior data handling capabilities to deliver seamless user experiences. The Buffer Status Reporting (BSR) mechanism in the MAC layer plays a pivotal role in ensuring efficient data transmission by reporting the status of buffers at the user equipment (UE) to the network. However, the traditional BSR mechanisms face challenges in meeting the low latency requirements critical for XR applications.

The present disclosure focuses on mitigating latency issues and ensuring robust connectivity, thereby enabling a seamless and responsive XR experience based on a new mechanism to report delay sensitive data to the base station. This solution aims to enhance data throughput, reduce latency, and improve overall network performance, thereby providing a more immersive and responsive XR experience.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

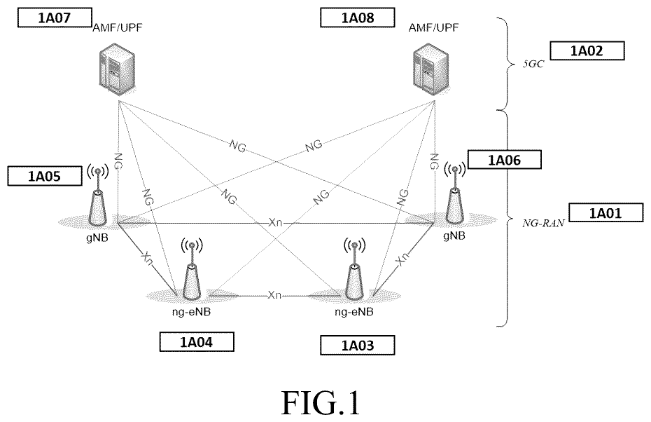

FIG. 1 is a diagram illustrating the architecture of a 5G system and a NG-RAN.

5G system consists of NG-RAN 1A01 and 5GC 1A02. An NG-RAN node is either:
>1: a gNB, providing NR user plane and control plane protocol terminations towards the UE; or
>1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
>1: Functions for Radio Resource Management such as Radio Bearer Control, Radio Admission Control, Connection Mobility Control, Dynamic allocation of resources to UEs in uplink, downlink and sidelink (scheduling); and
>1: IP and Ethernet header compression, uplink data decompression and encryption of user data stream; and
>1: Selection of an AMF at UE attachment when no routing to an MME can be determined from the information provided by the UE; and
>1: Routing of User Plane data towards UPF; and
>1: Scheduling and transmission of paging messages; and
>1: Scheduling and transmission of broadcast information (originated from the AMF or O&M); and
>1: Measurement and measurement reporting configuration for mobility and scheduling; and
>1: Session Management; and
>1: QoS Flow management and mapping to data radio bearers; and
>1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

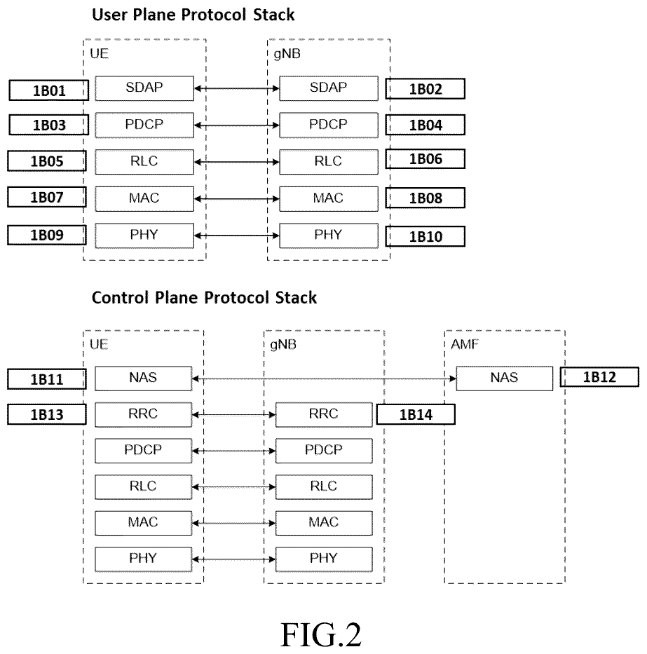

FIG. 2 is a diagram illustrating a wireless protocol architecture in a 5G system.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

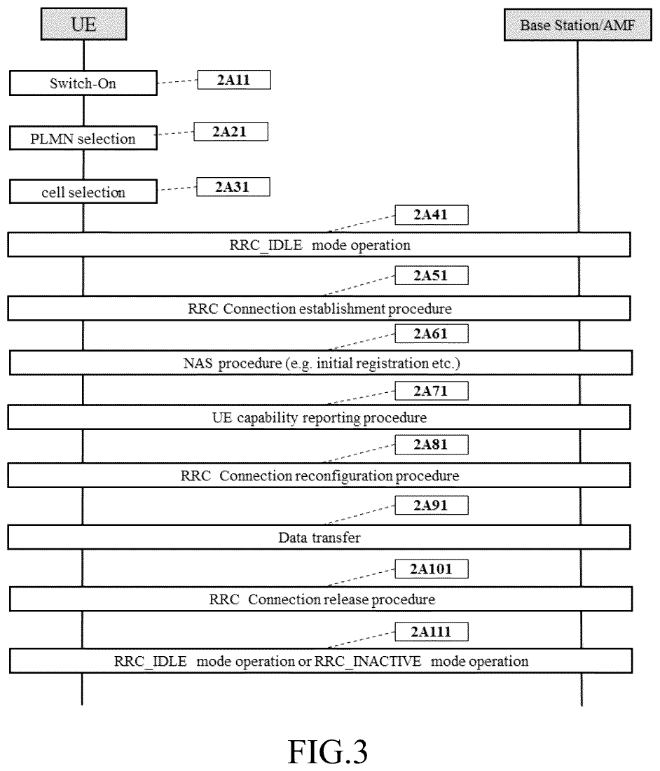

FIG. 3 illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc.) and various RRC functions (such as RRM and RLM and measurement etc.) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

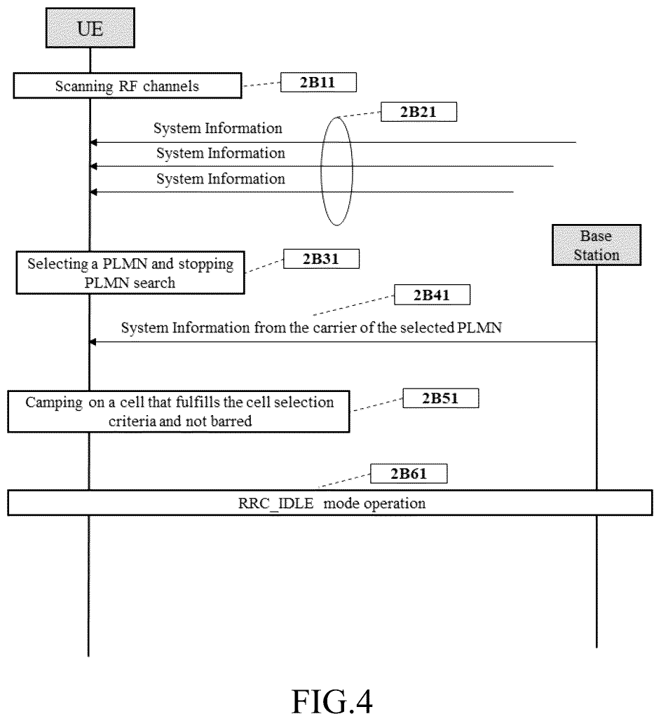

FIG. 4 illustrates the operation of the UE regarding PLMN selection and cell selection and cell reselection.

For PLMN selection, the UE may scan all RF channels to find available PLMNs 2B11. On each carrier, the UE shall search for the strongest cell and read its system information 2B21, in order to find out which PLMN(s) the cell belongs to. Each found PLMN is considered as a high quality PLMN (but without the RSRP value) provided that the measured RSRP value is greater than or equal to −110 dBm.

The search for PLMNs may be stopped when the PLMN to which the UE can register is found 2B31.

Once the UE has selected a PLMN, the cell selection procedure shall be performed in order to select a suitable cell of that PLMN to camp on.

The UE performs measurement on detectable cells and receives system information from whichever detectable cells that system information is readable 2B41.

The UE considers cell selection criterion S is fulfilled when:
Srxlev>0 AND
Squal>0
where, Srxlev is Cell selection RX level value (dB) and Squal is Cell selection quality value (dB). Srxlev is determined based on Measured cell RX level value (RSRP). Squal is determined based on Measured cell quality value (RSRQ).

The UE selects the cell that is part of the selected PLMN, and for which cell selection criteria are fulfilled, and of which cell access is not barred 2B51.

The UE camps on the selected cell. The UE perform RRC_IDLE mode operation 2B61 such as monitoring control channels to receive system information and paging and notification message.

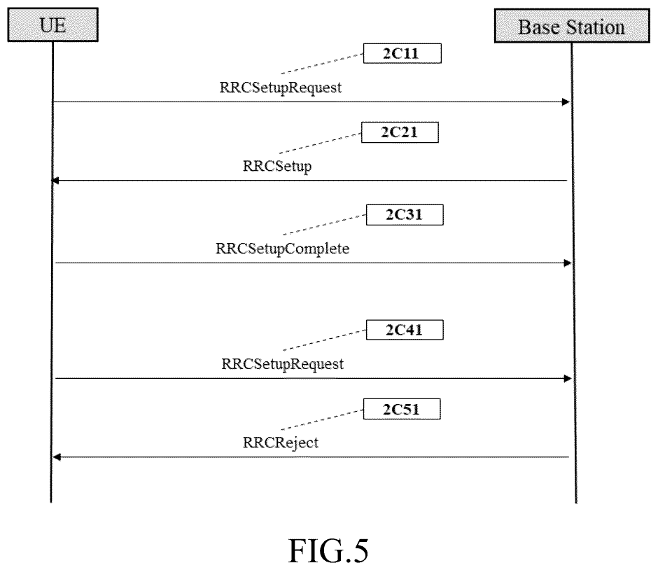

FIG. 5 illustrates RRC connection establishment procedure.

Successful RRC connection establishment procedure includes:
>1: transmission of RRCSetupRequest by the UE 2C11;
>1: reception of RRCSetup by the UE 2C21;
>1: transmission of RRCSetupComplete by the UE 2C31.

Unsuccessful RRC connection establishment procedure includes:
>1: transmission of RRCSetupRequest by the UE 2C41;
>1: reception of RRCReject by the UE 2C51;

RRCSetupRequest includes following fields and IEs:
>1: ue-Identity field contains InitialUE-Identity IE which contains:
>>2: ng-5G-S-TMSI-Part1 field containing a BIT STRING of 39 bit;
>1: establishmentCause field contains EstablishmentCause IE which contains:
>>2 enumerated value indicating either emergency, highPriorityAccess, mt-Access, mo-Signalling, mo-Data, mo-VoiceCall, mo-VideoCall, mo-SMS, mps-PriorityAccess, mcs-Priority Access etc

RRCSetup includes following fields and IEs:
>1: radioBearerConfig field containing a RadioBearerConfig IE;
>1: masterCellGroup field containing a CellGroupConfig IE.

RRCSetupComplete includes following fields and IEs:
>1: selectedPLMN-Identity field containing an integer indicating selected PLMN;
>1: dedicatedNAS-Message field containing a DedicatedNAS-Message which may contain various NAS message;
>1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identify the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
>1: perform the cell group configuration procedure in accordance with the received masterCellGroup;
>1: perform the radio bearer configuration procedure in accordance with the received radioBearerConfig;
>1: if stored, discard the cell reselection priority information provided by the cellReselectionPriorities or inherited from another RAT;
>1: enter RRC_CONNECTED;
>1: stop the cell re-selection procedure;
>1: consider the current cell to be the PCell;

The UE transmits to the base station RRCSetupComplete after performing above actions.

The UE sets the contents of RRCSetupComplete message as follows:
>1: set the ng-5G-S-TMSI-Value to ng-5G-S-TMSI-Part2;
>1: set the selectedPLMN-Identity to the PLMN selected by upper layers from the plmn-IdentityInfoList;
>1: include the s-NSSAI-List and set the content to the values provided by the upper layers;

For network to configure the UE with appropriate configurations, the network needs to know the capability of the UE. For this end, the UE and the base station perform UE capability transfer procedure.

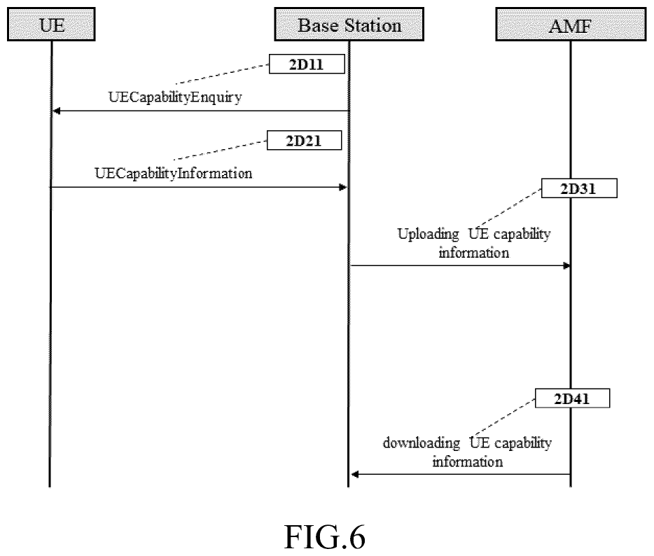

FIG. 6 illustrates UE capability transfer procedure.

UE capability transfer procedure consists of exchanging UECapabilityEnquiry 2D11 and UECapabilityInformation 2D21 between the UE and the base station.

In the UECapabilityEnquiry, the base station indicates which RAT is subject to capability reporting. UE transmits the capability information for the requested RAT in the UECapabilityInformation.

Once UECapabilityInformation is received, the capability information is uploaded to the AMF by the base station 2D31. When UE capability information is needed afterward, AMF provide it to the base station 2D41.

Based on the reported capability and other factors such as required QoS and call admission control etc., the base station performs RRC reconfiguration procedure with the UE.

RRC reconfiguration procedure is a general purposed procedure that is applied to various use cases such as data radio bearer establishment, handover, cell group reconfiguration, DRX configuration, security key refresh and many others.

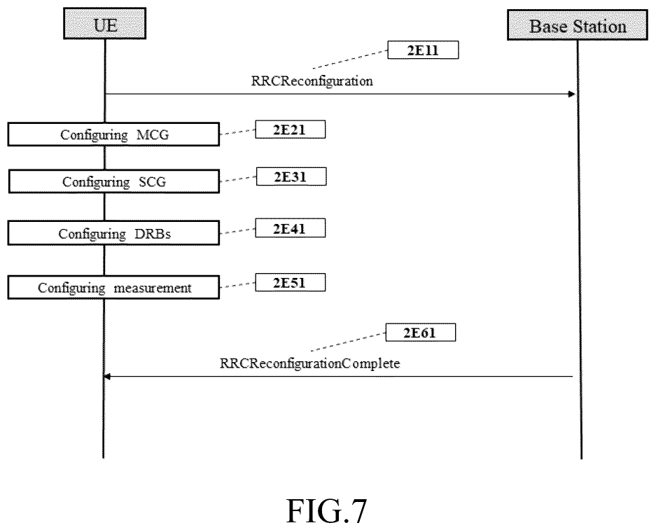

FIG. 7 illustrates RRC connection reconfiguration procedure.

RRC reconfiguration procedure consists of exchanging RRCReconfiguration 2E11 and RRCReconfigurationComplete 2E61 between the base station and the UE.

RRCReconfiguration may include following fields and IEs:
>1: rrc-TransactionIdentifier field contains a RRC-TransactionIdentifier IE;
>1: radioBearerConfig field contains a RadioBearerConfig IE;
>>2: radioBearerConfig field includes configuration information for SRBs and DRBs via which RRC messages and user traffic are transmitted and received;
>1: secondaryCellGroup field contains a CellGroupConfig IE;
>>2: secondaryCellGroup field includes configuration information for secondary cell group;
>>2: A cell group consists of a SpCell and zero or more SCells;
>>2: Cell group configuration information includes cell configuration information for SpCell/SCell and configuration information for MAC and configuration information for logical channel etc;
>1: measConfig field contains a MeasConfig IE;
>>2: measConfig field includes configuration information for measurements that the UE is required to perform for mobility and other reasons.
>1: masterCellGroup field contains a CellGroupConfig IE;

Upon reception of RRCReconfiguration, UE processes the IEs in the order as below. UE may:
>1: perform the cell group configuration for MCG based on the received masterCellGroup 2E21;
>1: perform the cell group configuration for SCG based on the received secondaryCellGroup 2E31;
>1: perform the radio bearer configuration based on the received radioBearerConfig 2E41;
>1: perform the measurement configuration based on the received measConfig 2E51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

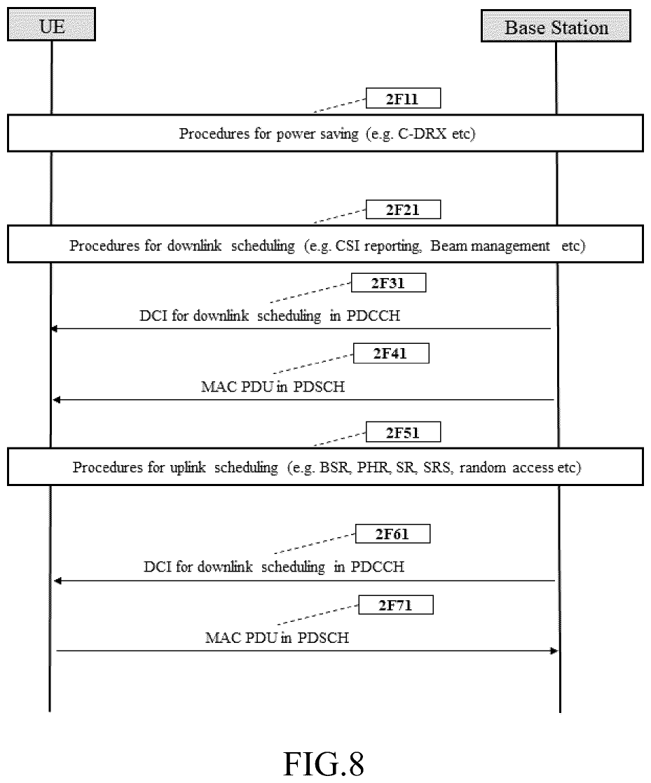

FIG. 8 illustrates data transfer procedure in RRC_CONNECTED state.

The UE and the base station may perform procedures for power saving such as C-DRX 2F11. The configuration information for C-DRX is provided to the UE within cell group configuration in the RRCReconfiguration.

The UE and the base station may perform various procedures for downlink scheduling 2F21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2F31. The base station transmits to the UE PDSCH corresponding to the DCI and containing a MAC PDU 2F41.

The UE and the base station may perform various procedure for uplink scheduling 2F51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2F61. The base station transmits to the UE PDSCH corresponding to the DCI and containing a MAC PDU 2F71.

RRC connection release procedure includes:
>1: transmission of RRCRelease from the base station to the UE 2G11; and
>1: transmission of acknowledgement for the RRCRelease from the UE to the base station 2G21; and
>1: state transition from RRC_CONNECTED to either RRC_IDLE or RRC_INACTIVE 2G31.

The purpose of RRC connection release procedure is either to release RRC connection (state transition to RRC_IDLE) or to suspend RRC connection (state transition to RRC_INACTIVE).

RRC connection release procedure may perform, in addition to state transition, various roles e.g., providing redirection information or providing cell reselection priorities.

The RRCRelease may include following fields for redirection:
>1: redirectedCarrierInfo field includes RedirectedCarrierInfo IE;
>>2: RedirectedCarrierInfo IE includes either CarrierInfoNR IE or RedirectedCarrierInfo-EUTRA IE;
>>>3: CarrierInfoNR IE includes ARFCN-ValueNR IE and SubcarrierSpacing IE;

The UE may perform cell selection on the carrier indicated by CarrierInfoNR IE or RedirectedCarrierInfo-EUTRA IE.

The RRCRelease may include following fields to configure cell reselection priority:
>1: cellReselectionPriorities field includes CellReselectionPriorities IE;
>>2: CellReselectionPriorities IE includes:
>>>3: FreqPriorityListNR IE;
>>>3: t320 field indicates a timer value for cell reselection priority validity;

During idle mode mobility, the UE applies the CellReselectionPriorities until T320 expires or stops.

The RRCRelease may include following fields/IEs to transition UE to RRC_INACTIVE state:
>1: suspendConfig field includes SuspendConfig IE;
>>2: fullI-RNTI field includes I-RNTI-Value IE;
>>2: shortI-RNTI field includes ShortI-RNTI-Value IE;
>>2: ran-PagingCycle field includes PagingCycle IE;
>>2: ran-NotificationAreaInfofield includes RAN-NotificationAreaInfo IE;
>>2: t380 field includes PeriodicRNAU-TimerValue;
>>2: nextHopChainingCount field includes NextHopChainingCount IE.
>>2: ran-ExtendedPagingCycle field includes ExtendedPagingCycle IE.

To transit the UE to RRC_INACTIVE, the base station includes SuspendConfig IE in the RRCRelease. To transit the UE to RRC_IDLE, the base station does not include SuspendConfig IE in the RRCRelease.

Upon reception of RRCRelease, UE may:
>1: delay the actions caused by RRCRelease 60 ms from the moment the RRCRelease message was received or optionally when lower layers indicate that the receipt of the RRCRelease message has been successfully acknowledged, whichever is earlier;
>1: store the cell reselection priority information provided by the cellReselectionPriorities and start T320;
>1: if the RRCRelease includes suspendConfig:
>>2: reset MAC and release the default MAC Cell Group configuration;
>>2: apply the received suspendConfig except the received nextHopChainingCount;
>>2: if the sdt-Config is configured:
>>>3: for each of the DRB in the sdt-DRB-List, consider the DRB to be configured for SDT;
>>>3: if sdt-SRB2-Indication is configured, consider the SRB2 to be configured for SDT;
>>>3: re-establish the RLC entity for each RLC bearer that is not suspended;
>>>3: trigger the PDCP entity to perform SDU discard for SRB1 and SRB2;
>>>3: if sdt-MAC-PHY-CG-Config is configured, configure the PCell with the configured grant resources for SDT and start the cg-SDT-TimeAlignmentTimer;
>>3: if srs-PosRRC-Inactive is configured, apply the configuration and instruct MAC to start the inactivePosSRS-TimeAlignmentTimer;
>>2: re-establish RLC entities for SRB1;
>>2: stop the timer T319 if running;
>>2: store in the UE Inactive AS Context the nextHopChainingCount received in the RRCRelease message, the current K_{gNB} and K_{RRCint} keys, the ROHC state, the EHC context(s), the UDC state, the stored QoS flow to DRB mapping rules, the application layer measurement configuration, the C-RNTI used in the source PCell, the cellIdentity and the physical cell identity of the source PCell, the spCellConfigCommon within ReconfigurationWithSync of the NR PSCell (if configured) and all other parameters configured except for:
>>>3: parameters within ReconfigurationWithSync of the PCell;
>>>3: parameters within ReconfigurationWithSync of the NR PSCell, if configured;
>>>3: parameters within MobilityControlInfoSCG of the E-UTRA PSCell, if configured;
>>>3: servingCellConfigCommonSIB;
>>2: suspend all SRB(s) and DRB(s) and multicast MRB(s), except SRB0 and broadcast MRBs;
>>2: indicate PDCP suspend to lower layers of all DRBs and multicast MRBs;
>>2: start timer T380, with the timer value set to t380;
>>2: indicate the suspension of the RRC connection to upper layers;
>>2: enter RRC_INACTIVE and perform cell selection;
>1: else (if the RRCRelease does not include suspendConfig):
>>2: perform the actions upon going to RRC_IDLE;

RRC connection resume procedure, in case of state transition from RRC_INACTIVE to RRC_CONNECTED, consists of RRC message exchange between the UE and the base station: RRCResumeRequest 2H11 and RRCResume 2H21 and RRCResumeComplete 2H31.

RRC connection resume procedure, in case of small data transmission without state transition, consists of RRC message exchange between the UE and the base station: RRCResumeRequest 2H41 and RRCRelease 2H51.

RRC connection resume procedure is triggered by the UE due to various reasons. For example, RRC connection resume procedure for state transition is triggered periodically (upon T380 expiry) or event-driven (upon cell change to different RAN area) or data driven (upon uplink or downlink data arrival). RRC connection resume procedure for small data transmission is triggered only if channel condition is above specific threshold and the amount of data is expected to be relatively small.

Upon initiation of RRC connection resume procedure, the UE performs some preliminary operation such as starting timers such as T319 (for supervising the procedure) and timeAlignmentTimer (for uplink timing alignment) and applying common channel configuration (for transmission of RRCResumeRequest). Then UE transmits RRCResumeRequest 2H11 or 2H41 to the base station. The message includes the UE identifier which can be used by the base station to identify the UE context where RRC connection information of the UE is stored.

When the base station determines that UE needs to be in RRC_CONNECTED state, the base station transmits RRCResume. Upon reception of RRCResume 2H21, the UE restores whole UE context based on the stored context at the time of RRCRelease reception and the received information in the RRCResume.

If the RRC connection resume procedure is triggered for small data transmission, the UE and the base station may perform data transfer during RRC connection resume procedure 2H51. When the base station determines that small data transmission is finished, the base station transmits RRCRelease 2H61.

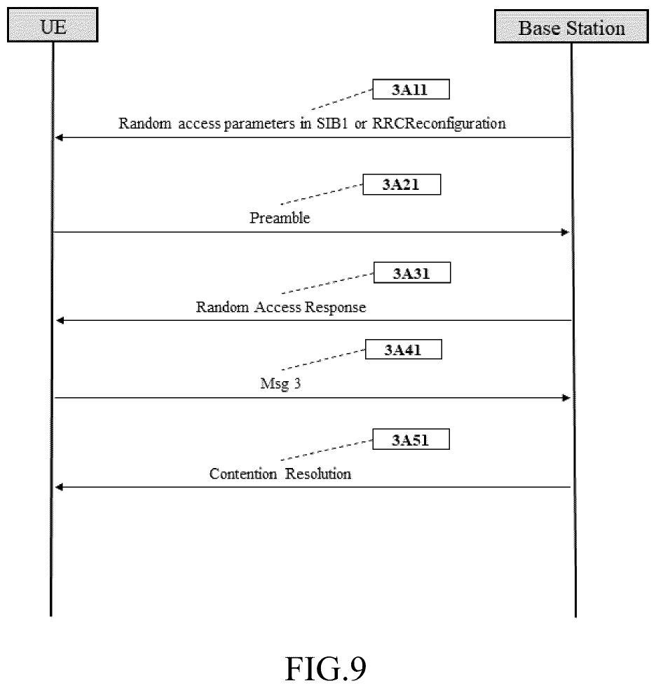

FIG. 9 illustrates random access procedure.

Random access procedure enables the UE to align uplink transmission timing, and indicate the best downlink beam, and transmit a MAC PDU that may contain CCCH SDU (e.g. RRCSetupRequest).

Random access procedure includes preamble transmission 3A21, random access response reception 3A31, Msg 3 transmission 3A41 and contention resolution 3A51.

Parameters for random access procedure are provided in SIB1 (in case of initial access) or in RRCReconfiguration (in case of handover) 3A11.

Random access procedure may be triggered by a number of events such as initial access from RRC_IDLE (e.g. RRC connection establishment procedure), DL or UL data arrival, request by RRC upon synchronous reconfiguration (e.g. handover) and RRC Connection Resume procedure from RRC_INACTIVE etc.

When the random access procedure is initiated, the UE may perform following actions in order:
>1: flush the buffer for Msg 3;
>1: initialize the counters for preamble transmission and power ramping;
>1: select the uplink carrier for performing the random access procedure based on a rsrp threshold (e.g. rsrp-ThresholdSSB-SUL);
>1: select the set of Random Access resources applicable to the current Random Access procedure;
>1: select a SSB based on a rsrp threshold (e.g. rsrp-ThresholdSSB); a SSB corresponds to a downlink beam;
>1: select a random access preamble group based on the pathloss of the selected SSB and the potential Msg3 size and various parameters (e.g. ra-Msg3SizeGroupA, preambleReceivedTargetPower, msg3-DeltaPreamble, messagePowerOffsetGroupB etc); Preamble group selection enables the UE to request bigger uplink grant for Msg 3 transmission if channel condition is good enough and the potential Msg 3 size is above a certain threshold;
>1: select a random access preamble randomly with equal probability from the random access preambles associated with the selected SSB and the selected random access preamble group;
>1: determine the next available PRACH occasion from the PRACH occasions corresponding to the selected SSB;
>1: determine the transmission power of the preamble;

$$>> 2 : preamble transmission power = pathloss + preambleReceivedTargetPower + DELTA\_PREAMBLE + ( PREAMBLE\_POWER \_RAMPING \_COUNTER - 1 ) \times PREAMBLE\_POWER \_RAMPING \_STEP + POWER\_OFFSET \_ 2 STEP\_RA$$

>1: transmit the preamble in the determined PRACH occasion with the determined transmission power;
>1; start ra-Response Window;
>1: monitor the PDCCH of the SpCell for Random Access Response(s) identified by the RA-RNTI while the ra-Response Window is running;
>1: receive Random Access Response contains a MAC subPDU with Random Access Preamble identifier corresponding to the transmitted preamble;
>1: process the received Timing Advanced Command and the received UL grant;
>1: transmit a Msg 3 based on the received UL grant;
>>2: Msg 3 may contain e.g. CCCH SDU such as RRCSetupRequest or RRCResumeRequest;
>1: start ra-ContentionResolutionTimer;
>1: monitor the PDCCH while the ra-ContentionResolutionTimer is running;
>1: consider Contention Resolution successful when MAC PDU containing a UE Contention Resolution Identity MAC CE is received;
>1: consider the Random Access procedure successfully completed.

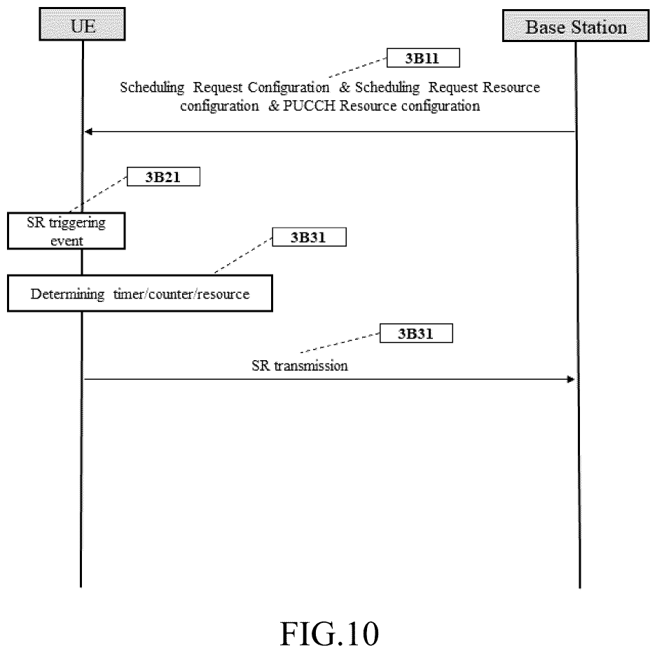

FIG. 10 illustrates scheduling request procedure based on dedicate scheduling request resource.

Unlike downlink traffic, the scheduler in the base station does not know when UE needs to be scheduled for uplink transmission. To enable uplink scheduling, the UE can be configured with scheduling request resource. When uplink resource is required for the UE, the UE can transmit a one-bit signal on the scheduling request resource based on the scheduling request procedure.

The base station provides to the UE configuration information for dedicate scheduling request procedure in RRCReconfiguration 3B11.

The configuration information includes four main components: mapping information between events and the counter/timer/time resource/frequency resource, configuration information for counter/timer, configuration information for time resource, and configuration information for frequency resource.

One or more instances of configuration information on counter/timer (e.g. SchedulingRequestToAddMod) can be provided to the UE; each of them is associated with an identifier (e.g. schedulingRequestId). An initial value for counter (e.g. sr-TransMax) defines the number of consecutive times for SR transmission that is allowed. The timer (sr-Prohibittimer) defines the minimum time duration between the consecutive SR transmission.

One or more instances of configuration information on scheduling request resource (e.g. SchedulingRequestResourceConfig) can be provided to the UE; each of them is associated with an identifier (schedulingRequestID). The configuration information further includes time domain information for the resource (e.g. periodicityAndOffset) and the identifier of the associated timer/counter (schedulingRequestResourceId) and the identifier of the associated frequency domain resource (PUCCH-ResourceId).

One or more instances of configuration information on PUCCH resource (e.g. PUCCH-Resource) can be provided to the UE; each of them is associated with an identifier (e.g. PUCCH-ResourceId). The configuration information includes identifier of PRB where the PUCCH resource starts and an indication whether intra-slot frequency hopping is enabled.

The base station can indicate UE which counter/timer shall be used for which SR triggering event by binding the SR triggering event with a schedulingRequestId.

SR triggering event can be: data arrival in logical channel, SCell beam failure recovery, positioning measurement gap activation/deactivation request etc.

When an SR triggering event occurs 3B21, the UE determines the associated counter/timer based on the mapping information between SR triggering event and schedulingRequestId. Based on the determined schedulingRequestID, the UE determines the associated PUCCH-Resource and the associated SchedulingRequestResource 3B31; more specifically, the UE determines that the SchedulingRequestResource of which configuration information includes schedulingRequestID is the SchedulingRequestResource associated with the timer/counter identified by the schedulingRequestID.

The UE transmits the SR:
>1: in the time/frequency resource determined from SchedulingRequestResource associated with the schedulingRequestId; and
>1: based on the prohibit timer and the initial counter value determined from the schedulingRequestId.

SchedulingRequestToAddMod and SchedulingRequestResource have one to one relationship between them.

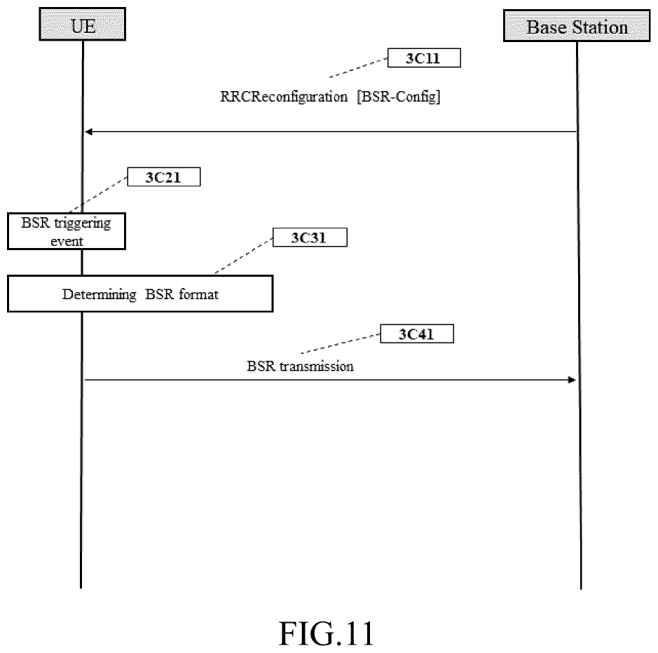

FIG. 11 illustrates buffer status reporting procedure.

Unlike downlink traffic, the scheduler in the base station does not know when and how much and how important data arrives in the UE. To provide information on buffer status, the UE may transmit a Buffer Status Report (BSR) MAC CE when deemed triggered. BSR MAC CE includes one or more Buffer Size field, each of which indicates the amount of data available for transmission across logical channels of a logical channel group.

The base station provides a BSR configuration via a dedicate RRC message such as RRCReconfiguration 3C11. The BSR configuration includes a timer controlling periodic reporting and other information. The mapping information between a logical channel and a logical channel group is also provided in the dedicate RRC message.

BSR can be triggered event-driven or periodically or based on padding. Upon a significant event that cause buffer status change or upon expiry of a timer or upon space for padding being available, BSR is triggered 3C21.

A BSR shall be triggered if any of the following events occur for activated cell group:
>1: UL data, for a logical channel which belongs to an LCG, becomes available to the MAC entity; and either
>>2: this UL data belongs to a logical channel with higher priority than the priority of any logical channel containing available UL data which belong to any LCG; or
>>2: none of the logical channels which belong to an LCG contains any available UL data.
>1: in which case the BSR is referred below to as ‘Regular BSR’;
>1: UL resources are allocated and number of padding bits is equal to or larger than the size of the Buffer Status Report MAC CE plus its subheader, in which case the BSR is referred below to as ‘Padding BSR’;
>1: retxBSR-Timer expires, and at least one of the logical channels which belong to an LCG contains UL data, in which case the BSR is referred below to as ‘Regular BSR’;
>1: periodicBSR-Timer expires, in which case the BSR is referred below to as ‘Periodic BSR’.

The UE determines the format of the BSR depending on which event triggers the BSR 3C31.

Based on the number of logical channel groups with data available for transmission, a short format and a long format are defined.

Based on whether all logical channels can be reported or not, a truncated format and the normal/full format are defined.

Short BSR and Short Truncated BSR include following fields:
>1: LCG ID field indicates the identifier of LCG whose buffer status is being reported.
>1: short Buffer Size field indicates the total amount of data available across all logical channels of a logical channel group. The amount of data is indicated in number of bytes. The length of this field is 5 bit.

Long BSR and Long Truncated BSR includes following fields:
>1: Bitmap field includes 8 bit. Each bit indicates the presence of the Buffer Size field for the corresponding logical channel group;
>1: long Buffer Size field indicates the total amount of data available across all logical channels of a logical channel group. The amount of data is indicated in number of bytes. The length of this field is 8 bit.

In principle, since the information contained in BSR triggered due to new uplink data or timer expiry is crucial for uplink scheduling, BSR format is determined solely based on the number of LCGs for reporting. On the other hands, the information contained in BSR triggered due to padding is supplementary information for uplink scheduling, BSR format is determined based on the number of LCGs and the size of padding space.

The UE transmits a Short BSR in the following case:
>1: only one LCG has data available for transmission and the BSR is triggered due to new uplink data or timer expiry; or
>1 only one LCG has data available for transmission and the size of padding is enough to accommodate the Short BSR.

The UE transmits a Short Truncated BSR in the following case:
>1: padding occurs (e.g. MAC SDUs or MAC CEs do not fill up all the available space of MAC PDU); and
>1: more than one LCG have data available for transmission; and
>1: the size of padding is not enough to accommodate a Long BSR or a Long Truncated BSR but enough to accommodate the Short Truncated BSR.

The UE transmits a Long BSR in the following case:
>1: more than one LCGs have data available for transmission and the BSR is triggered due to new uplink data or timer expiry.

The UE transmits a Long Truncated BSR in the following case:
>1: padding occurs; and
>1: more than one LCG have data available for transmission; and
>1: the size of padding is not enough to accommodate a Long BSR but enough to a Long Truncated BSR.

The UE transmits BSR 3B41. To get the uplink resource for BSR transmission, if the BSR is triggered for new uplink data that is important than what are stored previously, scheduling request procedure can be initiated beforehand.

A MAC PDU is a bit string that is byte aligned (i.e. multiple of 8 bits) in length. Bit strings are represented by tables in which the most significant bit is the leftmost bit of the first line of the table, the least significant bit is the rightmost bit on the last line of the table, and more generally the bit string is to be read from left to right and then in the reading order of the lines. The bit order of each parameter field within a MAC PDU is represented with the first and most significant bit in the leftmost bit and the last and least significant bit in the rightmost bit.

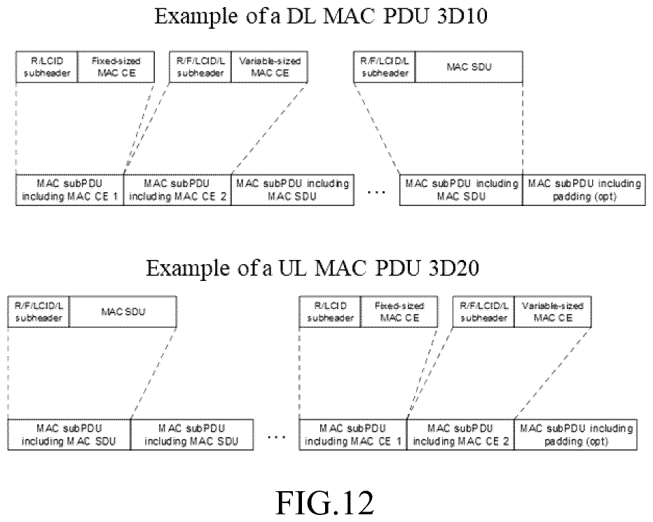

FIG. 12 illustrates MAC PDU format.

A MAC SDU is a bit string that is byte aligned (i.e. multiple of 8 bits) in length. A MAC SDU is included into a MAC PDU from the first bit onward.

A MAC CE is a bit string that is byte aligned (i.e. multiple of 8 bits) in length.

A MAC subheader is a bit string that is byte aligned (i.e. multiple of 8 bits) in length. Each MAC subheader is placed immediately in front of the corresponding MAC SDU, MAC CE, or padding.

A MAC PDU consists of one or more MAC subPDUs. Each MAC subPDU consists of one of the following:
>: A MAC subheader only (including padding);
>: A MAC subheader and a MAC SDU;
>: A MAC subheader and a MAC CE; and
>: A MAC subheader and padding.

A DL MAC PDU 3D10 includes MAC subPDUs for MAC CE first and MAC subPDUs for MAC SDU next. An UL MAC PDU 3D20 includes MAC subPDUs for MAC SDU first and MAC subPDUs for MAC CE next. The difference is to ensure that UE have sufficient processing time for MAC SDUs (e.g. pre-processing).

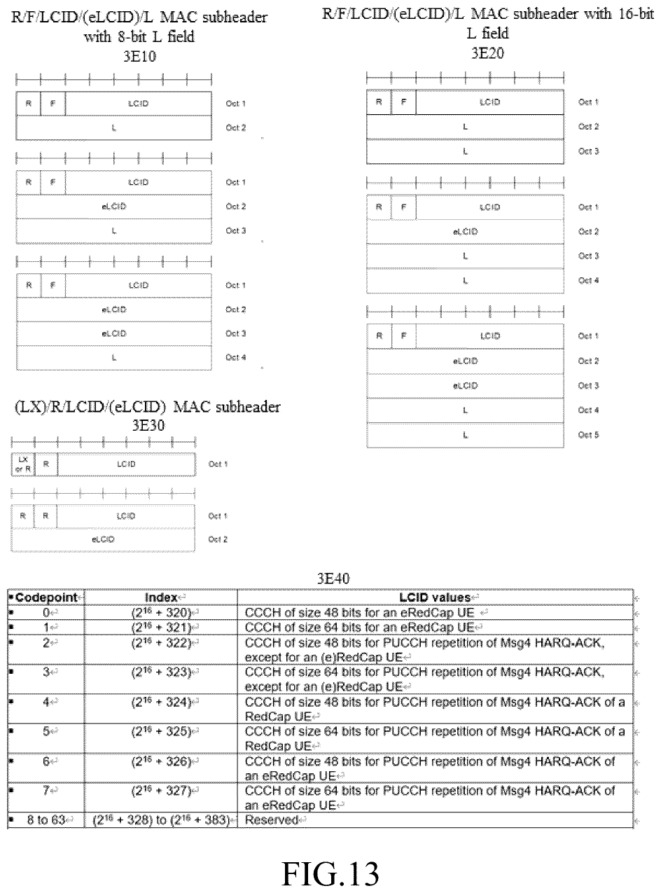

FIG. 13 illustrates MAC subheader format.

Each MAC subheader corresponds to either a MAC SDU, a MAC CE, or padding.

A MAC subheader except for fixed sized MAC CE, padding, and a MAC SDU containing UL CCCH consists of the header fields R/F/LCID/(eLCID)/L 3E20. A MAC subheader for fixed sized MAC CE and padding consists of the header fields R/LCID/(eLCID) 3E10. A MAC subheader for a MAC SDU containing UL CCCH consists of the header fields (LX)/R/LCID 3E30.

MAC CEs are placed together. DL MAC subPDU(s) with MAC CE(s) is placed before any MAC subPDU with MAC SDU and MAC subPDU with padding. UL MAC subPDU(s) with MAC CE(s) is placed after all the MAC subPDU(s) with MAC SDU and before the MAC subPDU with padding in the MAC PDU.

The MAC subheader consists of the following fields:
>LCID: The Logical Channel ID field identifies the logical channel instance of the corresponding MAC SDU or the type of the corresponding MAC CE or padding. There is one LCID field per MAC subheader. The size of the LCID field is 6 bits. If the LCID field is set to 34, one additional octet is present in the MAC subheader containing the eLCID field and follow the octet containing LCID field. If the LCID field is set to 33, two additional octets are present in the MAC subheader containing the eLCID field and these two additional octets follow the octet containing LCID field;
>eLCID: The extended Logical Channel ID field identifies the logical channel instance of the corresponding MAC SDU or the type of the corresponding MAC CE. The size of the eLCID field is either 8 bits or 16 bits.
>L: The Length field indicates the length of the corresponding MAC SDU or variable-sized MAC CE in bytes. There is one L field per MAC subheader except for subheaders corresponding to fixed-sized MAC CEs, padding, and MAC SDUs containing UL CCCH. The size of the L field is indicated by the F field;
>F: The Format field indicates the size of the Length field. There is one F field per MAC subheader except for subheaders corresponding to fixed-sized MAC CEs, padding, and MAC SDUs containing UL CCCH. The size of the F field is 1 bit. The value 0 indicates 8 bits of the Length field. The value 1 indicates 16 bits of the Length field;
>LX: The LCID extension field indicates the use of extended LCID space. The size of the LX field is 1 bit. The LX field set to 1 indicates the use of table 3E40, otherwise R bit is present instead (i.e. set to 0);

The MAC subheader is octet aligned.

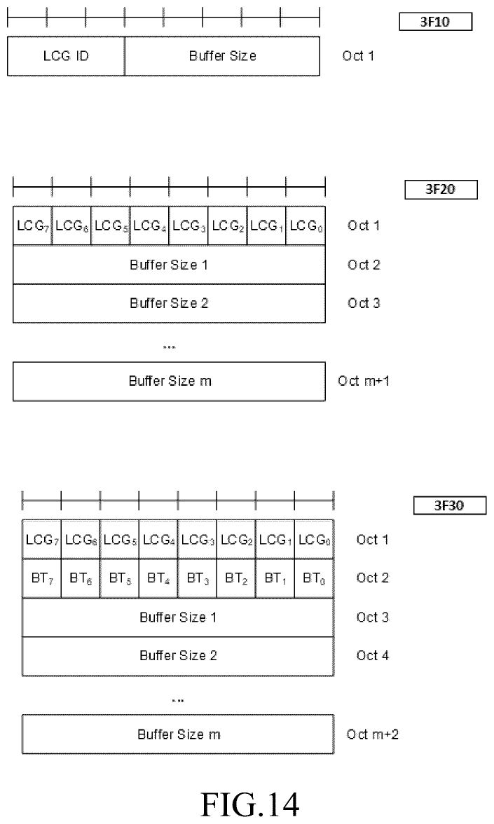

FIG. 14 is a diagram illustrating various formats of BSR.

Buffer Status Report (BSR) MAC CEs consist of either:
>: Short BSR format (fixed size) 3F10; or
>: Long BSR format (variable size) 3F20; or
>: Refined BSR format (variable size) 3F30.

The BSR formats are identified by MAC subheaders with LCIDs.

The Refined BSR format is identified by MAC subheaders with eLCID.

The fields in the BSR MAC CE are defined as follows:
>: LCG ID: The Logical Channel Group ID field identifies the group of logical channel(s) whose buffer status is being reported. The length of the field is 3 bits for the case of Short BSR and Short Truncated BSR formats, and 8 bits for the case of Extended Short BSR and Extended Short Truncated BSR formats;
>: LCGᵢ: this field indicates the presence of the Buffer Size field for logical channel group i. The LCGᵢ field set to 1 indicates that the Buffer Size field for the logical channel group i is reported. The LCGᵢ field set to 0 indicates that the Buffer Size field for the logical channel group i is not reported;
>: BTᵢ: this field indicates which buffer size table is used to encode the buffer size of the logical channel group i. The BTᵢ field set to 1 indicates that the third buffer size table is used for the logical channel group i. The BTᵢ field set to 0 indicates that the second buffer size table is used for the logical channel group i or the buffer size table is not used for the logical channel group i. UE sets the BTi field to 0 if LCGi field is 0. The UE sets the BTi field based on the total amount of data of LCGi available for transmission if LCGi field is 1.
>: Buffer Size: The Buffer Size field identifies the total amount of data available according to the data volume calculation procedure across all logical channels of a logical channel group after the MAC PDU has been built (i.e. after the logical channel prioritization procedure, which may result the value of the Buffer Size field to zero). The size of the RLC headers and MAC subheaders are not considered in the buffer size computation. For refined BSR format, if the amount of data for an LCG is within the closed range of the buffer sizes specified in the third table, the MAC entity shall use the third BSR table to set the value of this field. Otherwise, the MAC entity shall use the second BSR table. The amount of data in this field is indicated in number of bytes. The length of this field is 5 bit (in case of short BSR format) or 8 bits (in case of long BSR format or refined BSR format). The Buffer Size fields are included in ascending order based on the LCGᵢ.

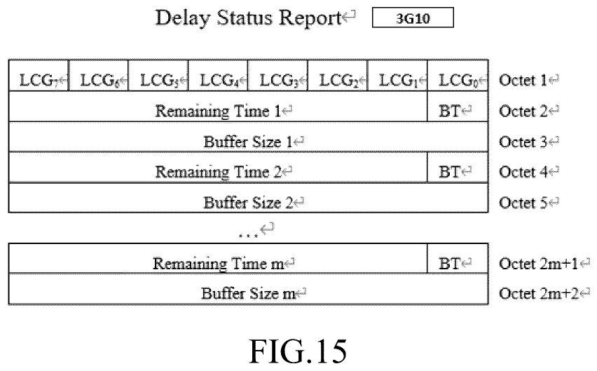

FIG. 15 is a diagram illustrating a format of DSR.

The Delay Status Report (DSR) MAC CE 3G10 is identified by MAC subheader with an eLCID.

The fields in the DSR MAC CE are defined as follows:
>: LCGᵢ: This field indicates the presence of delay information (i.e. the BT field and the Remaining Time and Buffer Size fields) for the LCG i. The LCGᵢ field set to 1 indicates that the delay information for the LCG i is reported. The LCGᵢ field set to 0 indicates that the delay information for the LCG i is not reported; UE includes the delay information for the LCG which is:
>>: configured for delay status reporting; and/or
>>: the smallest remaining value of PDCP discardTimers of all SDUs of all logical channels of the LCG is smaller than (below) remainingTimeThreshold. (LCG that have at least one delay-critical PDCP SDU);
>: BT: This field indicates which buffer size table is used to encode the buffer size of the associated logical channel group (e.g. the buffer size field in the next octet, or the buffer size field that follows Remaining time field that follows BT field);
>: Remaining time: This field indicates the shortest remaining value of PDCP discardTimer among all PDCP SDUs buffered for an LCG, at the time of the first symbol of the first PUSCH transmission that includes this DSR MAC CE. It is 7 bit. 0 (first value/index/code point) indicates 0˜1 ms, 1 indicates 1˜2 ms, 126 indicates 126˜127 ms and 127 (last value/index/code point) indicates shortest remaining value is above 127 ms;
>: Buffer Size: The Buffer Size field indicates the total amount of delay-critical UL data for an LCG according to the data volume calculation procedure for the associated PDCP and RLC entities, respectively after the MAC PDU has been built (after logical channel prioritization procedure). This field is indicated in bytes. The length of this field is 8 bits.

The reference time point of Remaining time field (which is at the time of the first symbol of the first PUSCH transmission that includes this DSR MAC CE) and the reference time point of Buffer Size field (according to the data volume calculation across all logical channels of a logical channel group after the MAC PDU has been built (i.e. after the logical channel prioritization procedure, which may result the value of the Buffer Size field to zero)) is different. It may increase UE complexity but enhance the usefulness of the information.

The Remaining Time field, the BT field, and the Buffer Size field for an LCG shall be reported in two consecutive octets. These three fields for different LCGs shall be included in a DSR MAC CE in ascending order based on the LCGi.

In this disclosure six gaps are defined: Type1Gap, Type2Gap, Type3Gap, Type4Gap, Type5Gap and Type6Gap.

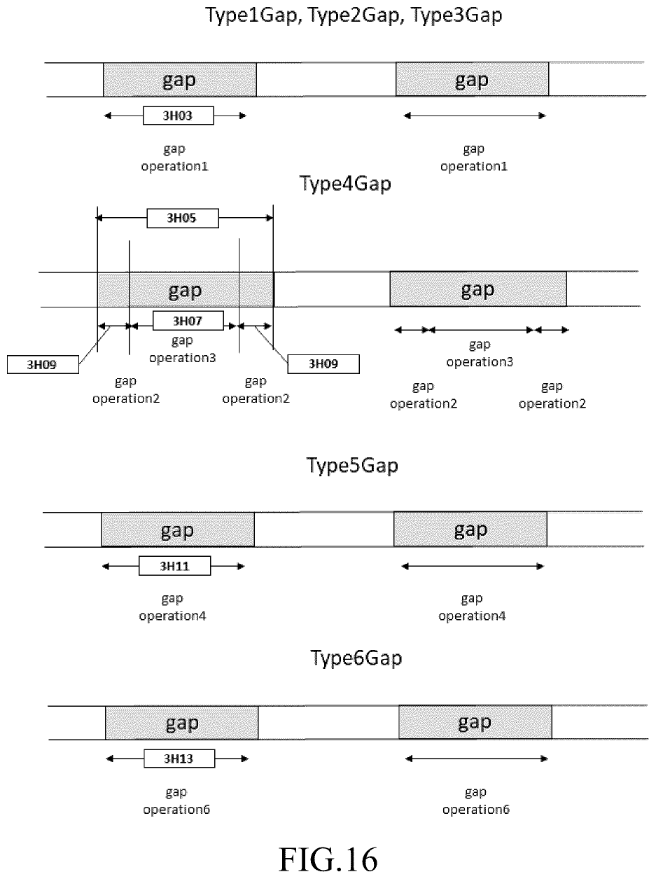

FIG. 16 is a diagram illustrating various gaps.

Type1Gap is used for RRM measurement on all FR1 frequencies or on all FR2 frequencies or on all frequencies. Type1Gap is always activated once it is configured. During a Type1Gap 3H03, UE performs gap operation1.

Type2Gap is used for RRM measurement on all frequencies. Type2Gap is activated only when an associated BWP is activated (or deactivated). During a Type2Gap 3H03, UE performs gap operation1-1. A Type2Gap can be called preconfigured gap.

Type3Gap is used for RRM measurement on specific frequency (or frequencies). Type3Gap is always activated once it is configured. During a Type3Gap 3H03, UE performs gap operation1-1. A Type3Gap can be called concurrent gap. A type3Gap is associated with a frequency if the ID of the type3Gap is indicated in the measurement object of the frequency.

One or more type3Gaps can be associated with a measurement object (i.e. a configuration information for a measurement object can include a plurality of measGapId(s)). In this case, the plurality of type3Gaps are used simultaneously for measurement on the frequency associated with the measurement object. It is useful in circumstances where adjacent neighboring cells are not synchronized with each other.

Type4Gap is used for RRM measurement on all FR1 frequencies or on all FR2 frequencies or on all frequencies. UE performs data activity like DL-SCH reception during Type4Gap. A Type4Gap 3H05 consists of two interruption periods 3H09) and one measurement period 3H07. During the interruption periods, UE performs gap operation 2. During the measurement period 3H07, UE performs gap operation 3. A Type4Gap can be called NCSG (Network Controlled Small Gap).

Type5Gap is used for activity in the other USIM. During a Type5Gap 3H11, UE performs gap operation4. A Type5Gap can be called MUSIM Gap.

Type6Gap is used for power management. During a Type6Gap 3H13, UE performs gap operation6. Type6Gap starts with an UL slot. UE determines the UL slot based on the tdd-UL-DL-ConfigurationCommon.

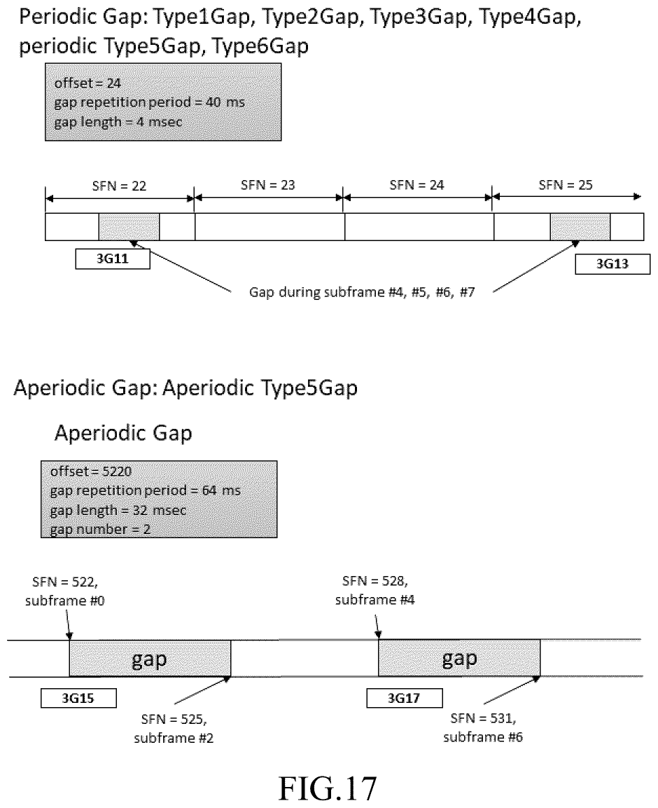

FIG. 17 is a diagram illustrating gap patterns of various gaps.

Type1Gap and Type3Gap and Type4Gap and Type6Gap are periodically occurring once they are configured. Type2Gap is periodically occurring once configured and activated. Type5Gap is either periodically occurring or aperiodically occurring once configured.

The pattern of periodic gaps is controlled by an offset parameter and a gap repetition period parameter and a gap length parameter. For example, when offset is 24 and gap repetition period is 40 ms and gap length is 4 ms, the first gap 3G11 occurs at subframe #4 of SFN 22 and continues 4 msec. The second gap 3G13 occurs at subframe #4 of SFN 25 and continues 4 msec and so on.

The pattern of aperiodic gaps is controlled by offset parameter and gap repetition period parameter and gap length parameter and gap number parameter. For example, when offset is 5220 and gap repetition period is 64 ms and gap length is 32 ms, the first gap 3G15 occurs at subframe #0 of SFN 522 and continues 32 msec. The second gap 3G17 occurs at subframe #4 of SFN 528 and continues 32 msec. Since gap number is 2, only two gaps occur.

To configure Type1Gap or Type2Gap or Type3Gap or Type4Gap, MeasGapConfig IE is used. MeasGapConfig IE is included in MeasConfig IE. MeasConfig IE is included in RRCReconfiguration message.

MeasGapConfig IE may include a gapFR2 field and a gapFR1 field and a gapUE field and a gapBwpToRemoveList field and a gapBwpToAddModList field and a gapUEToAddModList field and a gapFR2ToAddModList field and a gapFR1ToAddModList field.

gapFR2 field is included in the non-extended part of MeasGapConfig IE. gapFR1 field and gapUE IE are included in the first extended part of MeasGapConfig IE. gapBwpToRemoveList and gapBwpToAddModList and gapFRorUEToRemoveList and gapUEToAddModList and a gapFR2ToAddModList field and a gapFR1ToAddModList field are included in the second extended part of MeasGapConfig IE.

gapFR1 field and gapFR2 field and gapUE field are used to configure Type1Gap or Type4Gap. gapFR1 field and gapFR2 field and gapUE field can include GapConfig IE.

gapOffset and mgl and mgrp and mgta are included in the non-extended part of GapConfig IE.

refServCellIndicator can be included in the first extended part of GapConfig IE.

refFR2ServCellAsyncCA and mgl2 are included in the second extended part of GapConfig IE.

type2Indicator and type4Indicatorare included in the third extended part of GapConfig IE.

gapUEToRemoveList and gapUEToAddModList and gapFR2ToAddModList and a gapFR1ToAddModList and gapFR2ToRemoveList and gapFRIToRemoveList are used to configure or release Type2Gap or Type3Gap or Type4Gap.

To configure Type5Gap, Musim-GapConfig IE is used. Musim-GapConfig IE is included in RRCReconfiguration message.

Musim-GapConfig IE can include musim-GapConfigToRemoveList and musim-GapConfigToAddModList. musim-GapConfigToAddModList consist of plurality of musim-GapConfigToAddMod.

To configure Type6Gap, Type6GapConfig IE is used. Type6GapConfig IE is included in RRCReconfiguration message.

For efficient network operation and ensuring a seamless mobility, RRM measurement is essential. RRM measurement includes intra-frequency measurement and inter-frequency measurement and inter-RAT measurement. One purpose of RRM measurement is to find suitable cells for mobility (e.g. the neighbouring cell of which reference channel is better than that of the serving cell etc). RRM measurement may be understood as measurement for mobility purpose that are configured by network/GNB to the terminal in RRC layer. RRM measurement is configured by a set of parameters for measurement called MeasConfig.

UE is required to perform intra-frequency measurement and inter-frequency measurement (if configured) and inter-RAT measurement (if configured) based on one of more sets of parameters for measurement objects (each set is called MeasObject). UE may trigger measurement reporting procedure based on one or more sets of parameters for measurement reporting (each set is called ReportConfig).

Depending on UE capability, UE may not be able to perform RRM measurement and reception/transmission of other signals (such as PDCCH/PDSCH/PUSCH/PUCCH/SRS etc) simultaneously. For those UEs, network may configure measurement gap during which reception/transmission of signals related with data transmission/reception (PDCCH/PDSCH/PUSCH/PUCCH/SRS) is not performed so that the UE can perform RRM measurement.

For ensuring downlink positioning works, PRS measurement can be configured. PRS measurement may be understood as measurement for positioning that are configured by network/LMF to the terminal in LPP layer. PRS measurement is configured by a set of parameters called PosGapConfig. Measurement gap can be configured for UE to perform PRS measurement.

When UE is operating in high frequency (e.g. FR2), uplink transmission may need to be restricted to meet SAR requirements. For this purpose, UL gap can be configured by GNB. Besides the measurement gap and the UL gap, MUSIM gap can be configured for UE to perform MUSIM related operations during the gap.

During the measurement gap, specific set of DL operations and specific set of UL operations are restricted. During the UL gap, specific set of UL operations are restricted.

Each gap (including measurement gap, UL gap and MUSIM gap etc.) pose transmission/reception restrictions on the serving cells associated with the gap.

To meet QoS requirements in the context of the demanding scenarios and traffic characteristics requirements of XR, scheduling restriction during various gaps may need to be alleviated.

One thing to be considered is that gaps are configured to the terminal with certain purposes. Deactivating those gaps recklessly will harm system throughput due to e.g. delayed mobility or delayed reconfiguration that should have done timely manner.

There are number of possible solutions to strike the balance between meeting XR QoS requirement and keeping system maintenance in acceptable level.

### Possible Solutions

### <Adjusting Priorities of Tasks During Measurement Gap>

### Overview

One possible way is to indicate UE that the task priority during MG can change upon certain event (e.g. XR traffic is scheduled during MG). As consequences, in some MG, performing measurement is higher priority while in other MG, performing data transfer for XR traffic is higher priority.

When a specific PUSCH transmission or a specific PDSCH reception or specific SR transmission (that are related to XR traffic and will be discussed in detail later) that occur during time period associated with the MG/Gap is required/expected/scheduled in a serving cell, task priority of MG associated with the serving cell is changed appropriately as shown in the table below. MG may occur Tx/Rx restriction in slots adjacent to the MG. Time period associated with the MG/Gap is time period for which Tx/Rx restriction is applied due to MG/Gap. It will be discussed in more detail later.

Task priority may change as shown in table below.

TABLE 1

| | A specific MG is associated with one or | A specific MG is associated with one or |
|---|---|---|
| | more serving cell; and | more serving cell; and |
| | Neither specific PDSCH reception nor | Either specific PDSCH reception or specific |
| | specific PUSCH transmission is scheduled | PUSCH transmission is scheduled at one of |
| | in the one or more serving cells during the | the one or more serving cells during the |
| | specific MG | specific MG |
| 1^{st} priority task | Random Access related tasks: | Tx/Rx related tasks |
| | Random access related tx/rx in case that | Specific PDSCH reception or specific |
| | random access is performed in one of the one | PUSCH transmission; |
| | or more serving cells during the time period | HARQ feedback transmission for specific |
| | associated with the MG | PDSCH reception; |
| | | PDCCH monitoring for retransmission of |
| | | the specific PDSCH or of the specific |
| | | PUSCH; |
| | | Specific SR transmission |
| 2^{nd} priority task | Measurement related tasks: | Random Access related tasks: |
| | Measurement on the corresponding | Random access related tx/rx in case that |
| | frequencies/measurement objects | random access is performed in one of the one |
| | | or more serving cells during the time period |
| | | associated with the MG |
| 3^{rd} priority task | | Measurement related tasks: |
| | | Measurement on the corresponding |
| | | frequencies/measurement objects |

Note
Tx/Rx related tasks have no priority (not performed)

### Affected-MG

An affected MG is MG of which task priority changes (e.g. 1^{st} priority from measurement related tasks to Tx/Rx related tasks) when specific PDSCH reception or specific PUSCH transmission is scheduled/indicated/configured during the associated time period of the MG.

When a MG is affected (e.g. specific PDSCH reception or specific PUSCH transmission is scheduled/indicated/configured in the associated time period of the MG), UE transmit PUCCH/PUSCH/SRS or receive PDCCH/PDSCH/TRS/CSI-RS for CQI in the serving cells associated with the affected MG (i.e. UE behave as if the affected MG is deactivated in the associated serving cells).

### RRC Signaling

RRCReconfiguration may include an IE to indicate which MG is subject to this solution and which MG is not.

It could be a single bit indication (indicate that all MGs are potential affected-MG) or a list of affected-MGs or a field indicating gapType of affected-MG. Those fields may be included in MeasGapConfig.
>: rxtxPrioritized field:
>>: This field includes a single bit indicates “Prioritized”;
>>: The presence of this field is optional;
>>: If this field is absent, there is no affected-MG configured for the UE. MG task does not change even when specific PDSCH reception or specific PUSCH transmission is scheduled/indicated/configured during the time period associated with the MG.
>>: If this field is present, all MGs are affected-MG.
>: rxtxPrioritizedMGToAddModList:
>>: The list may include one or more MeasGapId IEs or one or more MeasPosPreConfigGapId IEs;
>>: The list indicates one or more affected-MGs;
>>: The presence of this field is optional;
>>: If this field is absent, there is no affected-MG configured for the UE.
>>: If this field is present, MG indicated in the list is affected-MG.
>: rxtxPrioritizedFR:
>>: This field includes two bit to indicate either per-UEgap or per-FR1gap or per-FR2gap.
>>: This field indicates a gapType that determines the affected-MG.
>>: The presence of this field is optional.
>>: If this field is absent, there is no affected-MG configured for the UE.
>>: If this field is present, MG of gapType indicated in the field is affected-MG. For example, if this field indicates per-UEgap, all MGs of which type is per-UEgap are affected-MG. If this field indicates per-FR1gap, all MGs of which type is per-FR1gap are affected-MG.

### <Implicitly Deactivating Measurement Gap>

### Overview

In this solution, GNB implicitly informs UE which MG is deactivated for XR traffic transmission/reception.

When a specific PUSCH transmission or a specific PDSCH reception or specific SR transmission that occur during time period associated with the MG is required/expected/scheduled in a serving cell, the MG associated with the serving cell is deactivated.

When a specific PUSCH transmission or a specific PDSCH reception or specific SR transmission that occur during time period associated with the MG is required/expected/scheduled in a serving cell, the MG associated with the serving cell is deactivated.

MG associated with a serving cell is deactivated in case that:
>: A specific PUSCH transmission is scheduled during time period associated with the MG; or
>: A specific PDSCH transmission is scheduled during time period associated with the MG.
>: A specific SR transmission is scheduled during time period associated with the MG

Alternatively,
During an activated MG,
>: UE performs, for one or more serving cells associated with the MG:
>>: unrestricted uplink operations; and
>>: unrestricted downlink operation;
>: UE does not perform:
>>: restricted uplink operations; and
>>: restricted uplink operations.

When a MG is deactivated, UE behave as if MG is not configured/activated.
>: UE performs, for one or more serving cells associated with the MG:
>>: unrestricted uplink operations;
>>: unrestricted downlink operation;
>>: restricted uplink operations; and
>>: restricted uplink operations.

### Affected-MG

An affected MG is MG that is deactivated when specific PDSCH reception or specific PUSCH transmission or specific SR transmission is scheduled/indicated/configured during the associated time period of the MG.

When a MG is affected (e.g. specific PDSCH reception or specific PUSCH transmission or specific SR transmission is scheduled/indicated/configured in the associated time period of the MG), UE performs unrestricted downlink operation and unrestricted uplink operation and restricted uplink operation and restricted downlink operation in the serving cell associated with the affected MG.

### RRC Signaling

RRCReconfiguration may include an IE to indicate which MG is subject to this solution and which MG is not.

It could be a single bit indication (indicate that all MGs are potential affected-MG) or a list of affected-MGs or a field indicating gapType of affected-MG. Those fields may be included in MeasGapConfig.

deactivationEnabled Field:
>: This field includes a single bit indicates “Enabled”;
>: The presence of this field is optional;
>: If this field is absent, there is no affected-MG configured for the UE. MG is not deactivated even when specific PDSCH reception or specific PUSCH transmission is scheduled/indicated/configured during the time period associated with the MG.
>: If this field is present, all MGs are affected-MG.
   rxtxPrioritizedMGToAddModList:
>: The list may include one or more MeasGapId IEs or one or more MeasPosPreConfigGapId IEs;
>: The list indicates one or more affected-MGs;
>: The presence of this field is optional;
>: If this field is absent, there is no affected-MG configured for the UE.
>: If this field is present, MG indicated in the list is affected-MG. rxtxPrioritizedFR:
>: This field includes two bit to indicate either per-UEgap or per-FR1gap or per-FR2gap.
>: This field indicates a gapType that determines the affected-MG.
>: The presence of this field is optional.
>: If this field is absent, there is no affected-MG configured for the UE.
>: If this field is present, MG of gapType indicated in the field is affected-MG. For example, if this field indicates per-UEgap, all MGs of which type is per-UEgap are affected-MG. If this field indicates per-FR1gap, all MGs of which type is per-FR1gap are affected-MG.

### <Temporarily Deactivating Gaps for XR Traffic>

### Overview

In this solution, GNB explicitly informs UE which MG is deactivated when XR traffic transmission/reception is required. New MAC CE for this purpose is defined. The MAC CE includes following fields:
>: MG ID field: this field indicates MG that is to be deactivated.
>: MG Type field: this field indicates whether the MG to be deactivated is MG configured by GapConfig (of which purpose is either positioning measurement of RRM measurement) or MG configured by PosGapConfig (of which purpose is only positioning measurement).
>: Start Time field: this field indicates from which point of time MG deactivation starts. This field includes a SFN and a slot number. The SFN is SpCell's SFN.
>: End Time field: this field indicates at which point of time MG deactivation ends. This field indicates number of slots.

Upon receiving the MAC CE, UE consider following MGs deactivated:
>: MGs as indicated by the MG ID field and MG type field during the time period between Start time and End time.

Alternatively, the MAC CE includes following fields:
>: perUEgap indicator: If this field is set to 1, all the MGs and positioning MGs are to be deactivated; If this field is set to 0 and if the MAC CE is received in FR1 serving cell, all FR1 MGs are to be deactivated; If this field is set to 1 and if the MAC CE is received in FR2 serving cell, all FR2 MGs and UL gaps are to be deactivated.
>: Start Time field
>: End Time field

Upon receiving the MAC CE, UE consider following MGs deactivated:
>: MGs as indicated by the perUEgap indicator field during the time period between Start time and End time.

UE performs unrestricted operations and restricted operations in the serving cells associated with the deactivated MG and during the time period associated with the deactivated MG.

### Affected-MG

An affected MG is MG that is deactivated when the MAC CE is received.

When a MG is affected (e.g. MAC CE deactivating the MG is received), UE performs unrestricted downlink operation and unrestricted uplink operation and restricted downlink operation and restricted uplink operation in the serving cell associated with the affected MG.

### RRC Signaling

RRCReconfiguration may include an IE to indicate whether MAC CE based MG deactivation is enabled or not.

explicitDeactivationEnabled Field:
>: This field includes a single bit indicates “Enabled”;
>: The presence of this field is optional;
>: If this field is absent, MAC CE based deactivation is not configured for the UE.
>: If this field is present, MAC CE based deactivation is configured for the UE.

### <Applying Time Pattern for XR Traffic Handling>

### Overview

Since time domain pattern of XR traffic is known to the GNB, GNB can inform UE a specific time pattern during which PDSCH/PUSCH/PDCCH/PUCCH is prioritized over RRM/Positioning measurement.

The time pattern could be configured for all serving cells or for specific set of serving cells.

### Time Pattern and Serving Cells

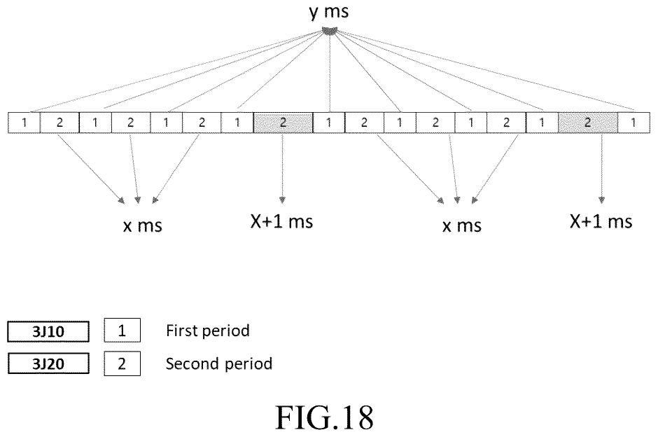

FIG. 18 is a diagram illustrating time pattern for measurement gap deactivation.

The time pattern consists of first period 3J10 and second period 3J20. Those two periods alternate each other. Length of the first period is static (y ms in the figure). Length of the second period is either static or not static. Length of the first period is explicitly configured in RRC. Length of the second period is determined based on the length of the first period and the periodicity of the first period.

If the periodicity is integer, the length of the second period is also static/stable. If the periodicity is non-integer, the length of the second period is either x ms or x+1 ms or x−1 ms. Second period with x ms length occurs n times and second period with x+1 ms length occurs once and then second period with x ms length occurs n times and so on. Or, second period with x ms length occurs n times and second period with x−1 ms length occurs once and then second period with x ms length occurs n times and so on.

During the first period PDSCH/PUSCH/PDCCH/PUCCH tx/rx is prioritized over RRM measurement and Positioning measurement in a specific set of serving cells.

During the second period and during the time period associated with MG, RRM measurement and Positioning measurement is prioritized over PDSCH/PUSCH/PDCCH/PUCCH tx/rx in a specific set of serving cells.

During the second period and outside of the time period associated with MG, PDSCH/PUSCH/PDCCH/PUCCH tx/rx is prioritized over RRM measurement and Positioning measurement in a specific set of serving cells.

### RRC Signalling

RRCReconfiguration may include an IE that includes:
>: A set of parameters for Time pattern; and
>: A parameter to indicate serving cells associated with the time pattern.

Time pattern can be configured by a field indicating the length of the first period and a field collectively indicating the offset and the periodicity.

The periodicity (of the first period) is either integer or non-integer. The non-integer periodicity results in staggering periodicity between two adjacent integer periodicities (e.g. x ms and x+1 ms) that staggers regularly by applying modulus operation.

The reason behind this is because periodicity of XR traffic may be non-integer as well.

Serving cells associated with the time pattern are either all active serving cells of UE (in FR1 and in FR2) or all active serving cells of UE in FR1 or all active serving cells of UE in FR2.

The parameter indicates serving cell could be one bit information that indicate either FR1 or FR2 (or either UE or FR1; or either UE or FR2). Absence of the parameter indicates UE (or FR2; or FR1).

If the parameter indicates FR1, serving cells associated with the time pattern are all active serving cells of UE in FR1.

If the parameter indicates FR2, serving cells associated with the time pattern are all active serving cells of UE in FR2.

If the parameter indicates UE, serving cells associated with the time pattern are all active serving cells of UE in FR1 and in FR2.

### Specific PDSCH Reception and Specific PUSCH Transmission

XR traffic is identified by GNB based on QoS flow and PDU sets and other traffic assistance information.

GNB consider DL traffic of specific QoS flow (received from UPF in GTP-U) as XR traffic. Each QoS flow for XR traffic is associated with PDU Set Delay Budget (PSDB). GNB consider DL XR traffic as delay-critical DL XR traffic if remaining time until PDSB is smaller than a threshold.

Since GNB does not know whether UL XR traffic is delay-critical or not, GNB instruct the UE to determine whether UL XR traffic is time critical or not.

GNB informs UE via RRCReconfiguration which QoS flow should be reported in UEAssistanceInformation. UEAssistanceInformation information includes for each QoS flow for XR traffic uplink traffic information (e.g. jitter range, burst arrival time, traffic periodicity etc.). Based on uplink traffic information, GNB may configure UE with configured grant for those XR UL traffic.

UE also triggers a specific MAC CE (e.g. DSR MAC CE) when remaining time until packet discard is smaller than a threshold (e.g. delay of the PDU set exceeds PSDB). Based on DSR MAC CE, GNB is aware that there is delay-critical UL XR traffic and schedule the UL traffic.

Specific PDSCH is:
>: Dynamic PDSCH (e.g. PDSCH scheduled by dynamic assignment) that carries MAC PDU containing first DL XR traffic; and
>: Semi-Persistent PDSCH (e.g. PDSCH scheduled by specific SPS) that carries MAC PDU containing second DL XR traffic.

Specific PUSCH is:
>: Dynamic PUSCH (e.g. PUSCH scheduled by dynamic grant) that carries MAC PDU containing first UL XR traffic;
>: Semi-Persistent PUSCH (e.g. PDSCH scheduled by specific CG) that carries MAC PDU containing second UL XR traffic;
>: Dynamic PUSCH that carries Refined BSR MAC CE (not padding Refined BSR MAC CE); or
>: Dynamic PUSCH that carries DSR MAC CE.

Specific SR is:
>: SR triggered by Refined BSR; or
>: SR triggered by DSR MAC CE.

Alternatively, since UE does not know what is included in the DL MAC PDU, defining the specific PDSCH by the contents of the DL MAC PDU may not work well. The contents of UL MAC PDU is determined after LCP procedure that occurs just before MAC PDU is built up. To allow more processing time to the terminal, alternative way to define specific PUSCH would be desirable.

Specific PDSCH is:
>: a PDSCH scheduled by dynamic assignment (e.g. DCI 1_0, DCI 1_1, DCI 1_2, or DCI 1_3),
>>: Dynamic assignment scheduling the PDSCH is received outside of the time period associated with the MG;
>>: PDSCH reception is within the time period associated with the MG;
>: a PDSCH scheduled by SPS activation command (e.g. DCI format 1_0, DCI 1_1 or 1_2 with special fields set to specific values),
>>: SPS activation command is received outside of the time period associated with the MG;
>>: The first PDSCH reception of SPS is within the time period associated with the MG; or
>: a PDSCH scheduled by SPS (e.g. PDSCH reception without DCI scheduling the PDSCH).
>>: PDSCH reception without assignment (either type 1 or type 2) is within the time period associated with the MG.

Specific PUSCH is:
>: a PUSCH scheduled by dynamic assignment (e.g. DCI 0_0, DCI 0_1 or DCI 0_2),
>>: Dynamic grant scheduling the PUSCH is received outside of the time period associated with the MG;
>>: PUSCH transmission is within the time period associated with the MG;
>: a PUSCH scheduled by CG activation command (e.g. DCI format 0_0, DCI 0_1 or 0_2 with special fields set to specific values),
>>: CG activation command is received outside of the time period associated with the MG;
>>: The first PUSCH transmission of CG is within the time period associated with the MG; or
>: a PUSCH scheduled by CG (e.g. PDSCH reception without DCI scheduling the PDSCH).
>>: PUSCH transmission without grant (either type 1 or type 2) is within the time period associated with the MG.

First XR traffic is delay-critical PDCP SDU and delay-critical RLC SDU. First XR traffic is PDCP SDU/PDU and RLC SDU/PDU that are stored across all radio bearers of LCG configured for DSR (e.g. LCG that can trigger DSR).

Second XR traffic is delay-critical PDCP SDU and delay-critical RLC SDU. Second XR traffic is PDCP SDU/PDU and RLC SDU/PDU that are stored across all radio bearers of LCG configured for DSR (e.g. LCG that can trigger DSR). Second XR traffic is PDCP SDU/PDU and RLC SDU/PDU that are stored in LCHs that are allowed to be transmitted over a specific set of CGs. (e.g. the LCH is configured with allowedCG-List and the allowedCG-List includes at least one CG that is associated with XR traffic/is allowed to be transmitted in MG).

Time Period Associated with Gaps

Time period associated with measurement gap is:
>: total interruption time due to the measurement gap (e.g. total interruption time during when receptions and transmission from associated serving cells are not performed); and
>: equal to measurement gap if MG timing advance (mgta) equal to zero is applied; and
>: measurement gap itself and the slots that are partly overlapped with the measurement gap (e.g. the first slot of which front is not measurement gap and the last slot of which back is not measurement gap) if MG timing advance not equal to zero is applied.

In case of carrier aggregation, per-UE measurement gap is equal across all serving cells while time period associated the measurement gap is different between serving cells in case that:
>: MG timing advance not equal to zero is applied.

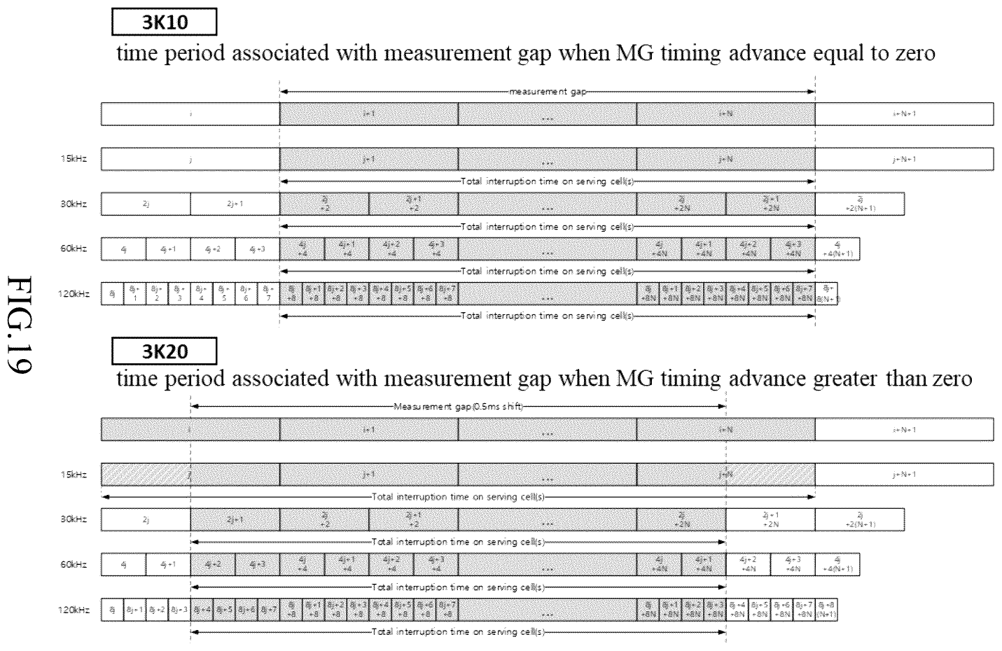

FIG. 19 is a diagram illustrating time period associated with measurement gap.

Time period associated with measurement gap when MG timing advance equal to zero is applied is illustrated in 3K10.

Time period associated with measurement gap when MG timing advance greater than zero is applied is illustrated in 3K20.

Serving Cells Associated with Gaps

Serving cells associated with Measurement/MUSIM/UL gap are determined as below.

Serving cells associated with gap are FR1 serving cells (frequency band of the serving cell is FR1 band; CD-SSB is on FR1):
>: If the gap is activated per-FR1 measurement gap.

Serving cells associated with gap are FR2 serving cells (frequency band of the serving cell is FR2 band; CD-SSB is on FR2):
>: If the gap is activated per-FR2 measurement gap; or
>: If the gap is UL gap.

Serving cells associated with gap are all serving cells (FR1 serving cells and FR2 serving cells):
>: If the gap is activated per-UE measurement gap; or
>: If the gap is MUSIM gap.
   Gaps Associated with a Serving Cell

Gaps associated with a serving cell is determined as below.

Gaps associated with a FR1 serving cell include:
>: per-FR1 measurement gap;
>: per-UE measurement gap; and
>: MUSIM gap.

Gaps associated with a FR2 serving cell include:
>: per-FR2 measurement gap;
>: per-UE measurement gap;
>: MUSIM gap; and
>: UL gap.

Whether the measurement gap is per-FR1 gap or per-FR2 gap or per-UE gap is indicated by gapType field in MeasGapConfig.

### Restricted Operation and Unrestricted Operation

Transmission/reception restrictions of measurement gap and of UL gap are explained in the table below. Similar restriction is applied to MUSIM gap.

TABLE 2

| | Measurement Gap | UL gap |
|---|---|---|
| Restricted uplink | Transmission of followings are not | Transmission of followings are not |
| operations (that are not | performed on the serving cells | performed on the serving cells |
| performed during the | associated with the gap: | associated with the gap: |
| gap) | UL-SCH/PUSCH except for | UL-SCH/PUSCH except for |
| | Msg3 or MSGA; | Msg3 or MSGA or based on |
| | CSI report including the valid | configured grant; |
| | CSI report during SCell | CSI report except the valid CSI |
| | activation procedure; | report during SCell activation |
| | L1 RSRP report including during | procedure; |
| | SCell activation procedure; | L1 RSRP report during SCell |
| | HARQ feedback. | activation procedure; |
| | SRS | HARQ feedback |
| | SR | SRS |
| Unrestricted uplink | Transmission of followings are | Transmission of followings are |
| operations (that are | performed on the serving cells | performed on the serving cells |
| performed during the | associated with the gap: | associated with the gap: |
| gap) | PPRCH preamble; | PPRCH preamble; |
| | UL-SCH/PUSCH for Msg3 or | UL-SCH/PUSCH for Msg3 or |
| | MSGA; | MSGA; |
| | | UL-SCH/PUSCH for configured |
| | | grant; |
| | | Valid CSI report during SCell |
| | | activation procedure; |
| | | Valid L1 RSRP report during |
| | | SCell activation procedure; |
| | | SR. |
| Restricted downlink | Reception of followings on the serving | None |
| operations (that are not | cells/frequencies associated with the | |
| performed during the | gap are not performed: | |
| gap) | DL-SCH/PDSCH based on SPS; | |
| | DL-SCH/PDSCH based on | |
| | dynamic grant; | |
| | PDCCH. | |
| Unrestricted downlink | Reception of followings on the | Reception of followings on the serving |
| operations (that are | frequencies associated with the gap are | cells/frequencies associated with the |
| performed during the | not performed: | gap are not performed: |
| gap) | SSB and/or CSI-RS (if RRM | SSB and/or CSI-RS; |
| | measurement is configured); | PRS; |
| | PRS (if PRS measurement is | TRS |
| | configured) | DL-SCH/PDSCH based on SPS; |
| | | DL-SCH/PDSCH based on |
| | | dynamic grant; |
| | | PDCCH. |

restricted operation may collectively indicate restricted uplink operation and restricted downlink operation and restrict.

unrestricted operation may collectively indicate unrestricted uplink operation and unrestricted downlink operation and restrict.

Restricted operation is performed outside gap and is not performed during activated gap. Restricted operation is performed during deactivated gap.

Unrestricted operation is performed outside gap and during gap.

unrestricted operation could be equivalent to Gap Operation 1.

restricted operation could be applied to serving-carrier-group during deactivated TypeXGap.

unrestricted operation could be applied to serving-carrier-group and measurement-object-group during activated TypeXGap.

### Deactivation Based on DCI

UE performs unrestricted operation and restricted operation in a set of serving cells during a MG in case that:
>: DCI is received and the DCI schedules PDSCH on a specific serving cell during the MG; or
>: DCI is received and the DCI schedules PUSCH on a specific serving cell during the MG.

UE determines whether the DCI schedules PDSCH on a specific serving cell during the MG based on time domain resource allocation field in DCI 1_0 or in DCI 1_1 or in DCI 1_2.

UE determines whether PDSCH scheduled by DCI is performed during a MG based on time domain resource allocation field in DCI 1_0 or in DCI 1_1 or in DCI 1_2.

UE determines whether the DCI schedule PUSCH on a specific serving cell during the MG based on time domain resource allocation field in DCI 0_0 or in DCI 0_1 or in DCI 0_2.

UE determines whether PUSCH scheduled by DCI is performed during a MG based on time domain resource allocation field in DCI 0_0 or in DCI 0_1 or in DCI 0_2.

UE performs unrestricted operation (and does not perform restricted operation) in the set of serving cells during the MG in case that:
>: The DCI scheduling PDSCH on any serving cell of the set of serving cells during the MG is not received; and
>: The DCI scheduling PUSCH on any serving cell of the set of serving cells during the MG is not received.

### Set of Serving Cells:

>: The set of serving cells are set of serving cells that are associated with the MG.
>: The set of serving cells are determined by gapType field of the MG and FreqBandIndicatorNR of each serving cell and activation status of each serving cell.
>: A serving cell is associated with a MG in case that:
>>: frequency band of the serving cell (indicated by FreqBandIndicatorNR of ServingCellConfigCommon) belongs to FR1;
>>: the MG gap is per-FR1 MG (as indicated by gapType of gapConfig or of PosGapConfig); and
>>: the serving cell is SpCell or the serving cell is activated SCell (all the active FR1 serving cells are associated with per FR1 MG).
>: A serving cell is associated with a MG in case that:
>>: frequency band of the serving cell (indicated by FreqBandIndicatorNR of ServingCellConfigCommon) belongs to FR2;
>>: the MG gap is per-FR2 MG (as indicated by gapType of gapConfig or of PosGapConfig); and
>>: the serving cell is SpCell or the serving cell is activated Scel (e.g. all the active FR2 serving cells are associated with per FR2 MG).
>: A serving cell is associated with a MG in case that:
>>: the MG gap is per-UE MG (as indicated by gapType of gapConfig or of PosGapConfig); and
>>: the serving cell is SpCell or the serving cell is activated SCell (e.g. all the active serving cells are associated with the per UE MG).
>: The specific serving cell is one of the set of serving cells.

UE performs unrestricted operation and restricted operation in a set of serving cells during a MG in case that:
>: DCI is received and the DCI schedules PDSCH on a specific serving cell during a period associated with the MG; or
>: PUSCH based on configured grant occurs on a specific serving cell during the period associated with the MG.

UE performs restricted operation (and does not perform unrestricted operation) in the set of serving cells during the MG in case that:
>: DCI scheduling PDSCH on any serving cell of the set of serving cells during the period associated with the MG is not received; and
>: PUSCH based on configured grant does not occur on any serving cell of the set of serving cells during the period associated with the MG.
   Period Associated with the MG:
>: MG is same across all serving cells associated with the MG.
>: Time period associated with the MG is different between serving cells associated with the MG if SCS of the active DL BWP of the serving cells are different.

### Set of Serving Cells

>: The set of serving cells are set of serving cells that are associated with the MG.
>: The set of serving cells are determined by gapType field of the MG and FreqBandIndicatorNR of each serving cell and activation status of each serving cell.
>: A serving cell is associated with a MG in case that:
>>: frequency band of the serving cell (indicated by FreqBandIndicatorNR of ServingCellConfigCommon) belongs to FR1;
>>: the MG gap is per-FR1 MG (as indicated by gapType of gapConfig or of PosGapConfig); and
>>: the serving cell is SpCell or the serving cell is activated SCell (all the active FR1 serving cells are associated with per FR1 MG).
>: A serving cell is associated with a MG in case that:
>>: frequency band of the serving cell (indicated by FreqBandIndicatorNR of ServingCellConfigCommon) belongs to FR2;
>>: the MG gap is per-FR2 MG (as indicated by gapType of gapConfig or of PosGapConfig); and
>>: the serving cell is SpCell or the serving cell is activated Scel (e.g. all the active FR2 serving cells are associated with per FR2 MG).
>: A serving cell is associated with a MG in case that:
>>: the MG gap is per-UE MG (as indicated by gapType of gapConfig or of PosGapConfig); and
>>: the serving cell is SpCell or the serving cell is activated SCell (e.g. all the active serving cells are associated with the per UE MG).

The specific serving cell is one of the set of serving cells.

### Specific SR

UE performs unrestricted operation and restricted operation in a set of serving cells during a MG in case that:
>: A specific SR is triggered on a specific serving cell during the MG.

UE performs restricted operation (and does not perform unrestricted operation) in the set of serving cells during the MG in case that:
>: A specific SR is not triggered on any serving cell of the set of serving cells during the MG; or
>: A SR is triggered on a serving cell that is not associated with the MG.

### Set of Serving Cells:

>: The set of serving cells are set of serving cells that are associated with the MG.
>: The set of serving cells are determined by gapType field of the MG and FreqBandIndicatorNR of each serving cell and activation status of each serving cell.
>: A serving cell is associated with a MG in case that:
>>: frequency band of the serving cell (indicated by FreqBandIndicatorNR of ServingCellConfigCommon) belongs to FR1;
>>: the MG gap is per-FR1 MG (as indicated by gapType of gapConfig or of PosGapConfig); and
>>: the serving cell is SpCell or the serving cell is activated SCell (all the active FR1 serving cells are associated with per FR1 MG).
>: A serving cell is associated with a MG in case that:
>>: frequency band of the serving cell (indicated by FreqBandIndicatorNR of ServingCellConfigCommon) belongs to FR2;
>>: the MG gap is per-FR2 MG (as indicated by gapType of gapConfig or of PosGapConfig); and
>>: the serving cell is SpCell or the serving cell is activated Scel (e.g. all the active FR2 serving cells are associated with per FR2 MG).
>: A serving cell is associated with a MG in case that:
>>: the MG gap is per-UE MG (as indicated by gapType of gapConfig or of PosGapConfig); and
>>: the serving cell is SpCell or the serving cell is activated SCell (e.g. all the active serving cells are associated with the per UE MG).
>: The specific serving cell is one of the set of serving cells.

Terminal performs followings:
receiving, by the terminal from a base station, a RRCReconfiguration message, the RRCReconfiguration message includes:
>: MeasConfig; and
>: CellGroupConfig
performing, by the terminal and during a measurement gap and for one or more serving cells associated with the measurement gap, a first set of operations (e.g. restricted operation and unrestricted operation) or a second set of operations (e.g. restricted operation) based on a triggered scheduling request,
wherein the first set of operations is performed in case that:
>: a first scheduling request is triggered (e.g. scheduling request is triggered for DSR MAC CE transmission);
>: SR resource for the first scheduling request (e.g. SR resource of scheduling requested triggered for DSR MAC CE transmission) is configured in one of the one or more serving cells associated with the measurement gap; and
>: SR resource for the first scheduling request resides in a specific time period associated with the measurement gap, wherein the second set of operations is performed in case that:
>: a first scheduling request is triggered (e.g. scheduling request is triggered for DSR MAC CE transmission);
>: SR resource for the first scheduling request is configured in a serving cell that is not associated with the measurement gap; and
>: SR resource for the first scheduling request resides in a specific time period associated with the measurement gap, wherein the second set of operations is performed in case that:
>: a second scheduling request is triggered (e.g. scheduling request triggered for other purpose, e.g. logical channel or BSR or BFR . . . );
>: SR resource for the second scheduling request (e.g. SR resource of scheduling requested triggered for other purpose) is configured in one of the one or more serving cells associated with the measurement gap; and
>: SR resource for the second scheduling request resides in a specific time period associated with the measurement gap

### Simplified Version

wherein the first set of operations is performed on the FR1 (or FR2) serving cells in case that:
>: the measurement gap is FR1 (or FR2) measurement gap;
>: a first scheduling request is triggered (e.g. scheduling request is triggered for DSR MAC CE transmission);
>: SR resource for the first scheduling request is configured in a FR1 (or FR2) serving cell; and
>: SR resource for the first scheduling request resides in a specific time period associated with the FR1 (or FR2) measurement gap,
wherein the second set of operations is performed on the FR1 (or FR2) serving cells in case that:
>: the measurement gap is FR2 (or FR1) measurement gap;
>: a first scheduling request is triggered (e.g. scheduling request is triggered for DSR MAC CE transmission);
>: SR resource for the first scheduling request is configured in a FR2 (or FR1) serving cell; and
>: SR resource for the first scheduling request resides in a specific time period associated with the FR1 (or FR2) measurement gap,
wherein the second set of operations is performed in case that:
>: a first scheduling request is triggered (e.g. scheduling request is triggered for DSR MAC CE transmission);
>: SR resource for the first scheduling request is configured in a serving cell that is not associated with the measurement gap; and
>: SR resource for the first scheduling request resides in a specific time period associated with the measurement gap,
wherein the second set of operations is performed in case that:
>: a second scheduling request (scheduling request configured for other purpose, e.g. logical channel or BSR or BFR . . . ) is triggered;
>: SR resource for the second scheduling request is configured in one of the one or more serving cells associated with the measurement gap; and
SR resource for the second scheduling request resides in a specific time period associated with the measurement gap.

SR resource and SR transmission occasion and SR configuration are used interchangeably.

“reside in” and “is colliding with” and “occurs within” are used interchangeably.

SR resource for the first scheduling request is equivalent to SR resource of logical channel that triggers the DSR

SR resource for the second scheduling request is equivalent to SR resource of logical channel that triggers BSR or SR resource for BFR or SR resource for positioning MG request.

During an activated measurement gap that is not colliding with transmission occasion of SR triggered for DSR in one of Serving Cell(s) in the corresponding frequency range of the measurement gap (during which SR triggered for DSR does not occur in one of Serving Cell(s) in the corresponding frequency range of the measurement gap), the MAC entity shall, on the Serving Cell(s) in the corresponding frequency range of the measurement gap configured by measGapConfig as specified in TS 38.331 [5]:
>: not perform the transmission of HARQ feedback, SR, and CSI;
>: not report SRS;
>: not transmit on UL-SCH except for Msg3 or the MSGA payload as specified in clause 5.4.2.2;
>: if the ra-ResponseWindow or the ra-ContentionResolutionTimer or the msgB-Response Window is running, or if there is an ongoing RACH-less LTM cell switch, or if there is an ongoing RACH-less handover in a terrestrial network:
>>: monitor the PDCCH as specified in clauses 5.1.4 and 5.1.5.
>: else:
>>: not monitor the PDCCH;
>>: not receive on DL-SCH.

During an activated measurement gap that is colliding with transmission occasion of SR triggered for DSR in one of Serving Cell(s) in the corresponding frequency range of the measurement gap (during which SR triggered for DSR occurs in one of Serving Cell(s) in the corresponding frequency range of the measurement gap), the MAC entity shall, on the Serving Cell(s) in the corresponding frequency range of the measurement gap configured by measGapConfig:
>: not perform transmission of SR triggered for other than DSR, and CSI;
>: not report SRS;
>: not transmit on UL-SCH except for Msg3 or the MAGA payload or DSR MAC CE or MAC SDUs from specific LCHs/LCGs;
>: transmit on UL-SCH for Msg3 or the MAGA payload or DSR MAC CE or MAC SDUs from specific LCHs/LCGs;
>: perform transmission of HARQ feedback;
>: perform transmission of SR triggered for DSR;
>: monitor PDCCH;
>: receive on DL-SCH.

### <Configured Grant>

### Multi-PUSCH CG

Terminal performs followings:
receiving, by the terminal from a base station, a RRCReconfiguration message, the RRCReconfiguration message includes:
>: MeasConfig; and
>: CellGroupConfig
>>: ConfiguredGrantConfig
>>>: periodicity
>>>: nrofSlotsInCG-Period
>>>: nrofBitsInUTO-UCI
performing, by the terminal and during a measurement gap and for one or more serving cells associated with the measurement gap, a first set of operations (restricted operation and unrestricted operation) or a second set of operations (restricted operation) based on one or more configured grants.
wherein the first set of operations is performed in case that:
>: a one or more CG PUSCH transmissions of multiple CG PUSCH transmissions within a single period of a CG configuration (Multi-PUSCH CG) is colliding with a measurement gap in time domain;
>: at least one of the one or more CG PUSCH transmission is indicated as used in UTO-UCI;
>: the multi-PUSCH CG configured grant is configured in the one of the one of more serving cells associated with the measurement gap.
wherein the second set of operations is performed in case that:
>: a one or more CG PUSCH transmissions of multiple CG PUSCH transmissions within a single period of a CG configuration (Multi-PUSCH CG) is colliding with a measurement gap in time domain;
>: all of the one or more CG PUSCH transmissions are indicated as unused in UTO-UCI;
>: the multi-PUSCH CG configured grant is configured in the one of the one of more serving cells associated with the measurement gap.
wherein the second set of operations is performed in case that:
>: a one or more CG PUSCH transmissions of multiple CG PUSCH transmissions within a single period of a CG configuration (Multi-PUSCH CG) is colliding with a measurement gap in time domain;
>: at least one of the one or more CG PUSCH transmission is indicated as used in UTO-UCI;
>: the multi-PUSCH CG configured grant is configured in a serving cell that is not one of the one of more serving cells associated with the measurement gap.

A multi-PUSCH configured grant has multiple consecutive configured uplink grants within a periodicity. Both Type 1 and Type 2 can be configured for a multi-PUSCH configured grant by RRC.

nrofSlotsInCG-Period: the number of configured uplink grants in a periodicity of a multi-PUSCH configured grant.

During a single period, nrofSlotsInCG-Period of CG PUSCH transmissions (Transmission Occasions) are performed

### XR Specific CG

Terminal performs followings:
receiving, by the terminal from a base station, a RRCReconfiguration message, the RRCReconfiguration message includes:
>: MeasConfig; and
>: CellGroupConfig
performing, by the terminal and during a measurement gap and for one or more serving cells associated with the measurement gap, a first set of operations (restricted operation and unrestricted operation) or a second set of operations (restricted operation) based on one or more configured grants.
wherein the first set of operations is performed in case that:
>: a configured grant is colliding with a measurement gap in time domain;
>: At least one of specific logical channels is allowed to use the configured grant (e.g. LogicalChannelConfig of the at least one specific logical channel includes an allowedCG-List, and the configured grant is indicated/listed in the allowedCG-List)
>: the configured grant is configured in the one of the one of more serving cells associated with the measurement gap (e.g. ConfiguredGrant of the configured grant is included in ServingCellConfig of the one or more serving cells).
wherein the second set of operations is performed in case that:
>: a configured grant is colliding with a measurement gap in time domain;
>: None of specific logical channels is allowed to use the configured grant (e.g. LogicalChannelConfig of any of specific logical channels includes an allowedCG-List that indicates/lists the configured grant).
wherein the second set of operations is performed in case that:
>: a configured grant is colliding with a measurement gap in time domain;
>: At least one of specific logical channel is allowed to use the configured grant;
>: the configured grant is configured in a serving cell that is not associated with the measurement gap.
wherein the first set of operations is performed in case that:
>: a one or more CG PUSCH transmissions of multiple CG PUSCH transmissions within a single period of a CG configuration (Multi-PUSCH CG) is colliding with a measurement gap in time domain;
>: At least one of specific logical channels is allowed to use the Multi-PUSCH CG.
>: at least one of the one or more CG PUSCH transmission is indicated as used in UTO-UCI;
>: the multi-PUSCH CG configured grant is configured in a serving cell that is not associated with the measurement gap.
wherein the second set of operations is performed in case that:
>: a one or more CG PUSCH transmissions of multiple CG PUSCH transmissions within a single period of a CG configuration (Multi-PUSCH CG) is colliding with a measurement gap in time domain;
>: none of specific logical channels is allowed to use the Multi-PUSCH CG, wherein the second set of operations is performed in case that:
>: a one or more CG PUSCH transmissions of multiple CG PUSCH transmissions within a single period of a CG configuration (Multi-PUSCH CG) is colliding with a measurement gap in time domain;
>: At least one of specific logical channels is allowed to use the Multi-PUSCH CG.
>: at least one of the one or more CG PUSCH transmission is indicated as used in UTO-UCI;
>: the multi-PUSCH CG configured grant is configured in a serving cell that is not associated with the measurement gap.
wherein the specific logical channels includes one or more logical channels, each of which:
>: is associated with a PDCP that is configured with pdu-SetDiscard; or
>: belongs to a LCG that is configured with remainingTimeThreshold (e.g. logical channel group of which leg-Id is listed in LCG-DSR-Config).

### NCSG

For NCSG, UE performs required operations based on whether the specific period is colliding with visible interruption period.

Terminal performs followings.
receiving, by the terminal from a base station, a RRCReconfiguration, wherein the RRCReconfiguration includes:
>: MeasConfig; and
>: CellGroupConfig;
establishing, by the terminal and based on a specific equation and a mgta, a second period (measurement gap; ML);
>: wherein the specific equation consists of SFN, T, gapOffset and MGRP;
>: wherein the specific equation determines the first subframe of the second period;
determining, by the terminal and based on the second period, a first period and a third period;
>: wherein the first period (VIL1) includes nr_of_slot slots;
>: wherein the last slot of the first period occurs immediately before (the first slot of) the second period;
>: wherein the third period (VIL2) includes nr_of_slot slots;
>: wherein the first slot of the third period occurs immediately after (the last slot of) the second period;
>: wherein nr_of_slot of a serving cell is determined based on FR (frequency region) and SCS
>>: In FR1: nr_of_slot=1 in 15 kHz; nr_of_slot=2 in 30 kHz; nr_of_slot=4 in 60 kHz; nr_of_slot=8 in 120 kHz.
>>: In FR2: nr_of_slot=3 in 60 kHz; nr_of_slot=6 in 120 kHz.
>: wherein the starting/first subframe of the second period and the ending/last subframe of the second period are same across all the specific serving cells.
>: wherein nr_of_slot of a serving cell and nr_of_slot of another serving cell are different in case that SCS are different.
determining, by the terminal, whether to perform transmission and reception on specific serving cells associated with the second gap during the first period and the third period; and
>: wherein the specific serving cells associated with the second period is determined based on gapType field in the GapConfig IF of the second gap.
>>: The specific serving cells associated with the second period are serving cells in FR1 in case that gapType indicates perFR1 (per-FR1 measurement gap).
>>: The specific serving cells associated with the second period are serving cells in FR2 in case that gapType indicates perFR2 (per-FR2 measurement gap).

The specific serving cells associated with the second period are all serving cells (in FR1 and in FR2) in case that gapType indicates perUE (per-UE measurement gap).

### Based on Uplink Transmission

performing, by the terminal and based on the determination, transmission and reception on the specific serving cells associated with the second period,
>: wherein transmission and reception on the specific serving cells are performed during the second period,
>: wherein transmission and reception on the specific serving cells are performed during the first period in case that:
>>: a specific uplink signal is to be transmitted on a serving cell of the specific serving cells during the first period,
>: wherein transmission and reception on the specific serving cells are not performed during the first period in case that:
>>: the specific uplink signal is to be transmitted on none of the specific serving cells during the first period,
>: wherein transmission and reception on the specific serving cells are performed during the third period in case that:
>>: the specific uplink signal is to be transmitted on a serving cell of the specific serving cells during the first period,
>: wherein transmission and reception on the specific serving cells are not performed during the third period in case that:
>>: the specific uplink signal is not to be transmitted on any of the specific serving cells during the first period,
wherein the specific uplink signal is to be transmitted on a serving cell of the specific serving cells during the first/third period mean:
>: dynamic grant based PUSCH on the serving cell of the specific serving cells is scheduled during the first/third period (DCI scheduling PUSCH on at least one serving cell of the specific serving cells during the first/third period is received); or
>: configured grant (based PUSCH) for initial transmission occurs on the specific serving cell during the first/third period; or
>: configured grant (based PUSCH) for autonomous retransmission occurs on specific configured grant during the first/third period.
wherein the specific uplink signal is not to be transmitted on any of the specific serving cells during the first/third period mean:
>: dynamic grant based PUSCH on none of the specific serving cells is scheduled during the first/third period; and
>: configured grant (based PUSCH) for initial transmission occurs on none of the specific serving cells during the first/third period; and
>: configured grant (based PUSCH) for autonomous retransmission occurs on none of the specific configured grant during the first/third period.

### Based on Downlink

performing, by the terminal and based on the determination, transmission and reception on the specific serving cells associated with the second period,
>: wherein transmission and reception on the specific serving cells are performed during the first period in case that:
>>: a specific downlink signal is to be received on a serving cell of the specific serving cells during the first period,
>: wherein transmission and reception on the specific serving cells are not performed during the first period in case that:
>>: the specific downlink signal is to be received on none of the specific serving cells during the first period,
>: wherein transmission and reception on the specific serving cells are performed during the third period in case that:
>>: the specific downlink signal is to be received on a serving cell of the specific serving cells during the first period,
>: wherein transmission and reception on the specific serving cells are not performed during the third period in case that:
>>: the specific uplink signal is not to be transmitted on any of the specific serving cells during the first period,
wherein the specific downlink signal is to be received on a serving cell of the specific serving cells during the first/third period mean:
>: dynamic assignment based PDSCH on the serving cell of the specific serving cells is scheduled during the first/third period (DCI scheduling PDSCH on at least one serving cell of the specific serving cells during the first/third period is received); or
>: configured assignment (based PDSCH) for initial transmission occurs on the specific serving cell during the first/third period.
wherein the specific uplink signal is not to be transmitted on any of the specific serving cells during the first/third period mean:
>: dynamic assignment based PDSCH on none of the specific serving cells is scheduled during the first/third period; and
configured assignment (based PDSCH) for initial transmission occurs on none of the specific serving cells during the first/third period.

### Activation

For Positioning Measurement Gap, UE first determines whether the gap is activated or not, before applying the gap.

For pre measurement gap, UE first determines whether gap is activated or not before applying the gap.

If the measurement gap is deactivated, UE creates a new gap to perform measurement. It can be done by temporal MG activation MAC CE. It can be done based on predefined offset defined per gap, wherein UE performs measurement after OFFSET if the measurement gap is deactivated.

Definition of activation/deactivation of various types of gaps is as follows:
>: Deactivating MG is equivalent to dropping MG. During a period associated with MG, UE perform unrestricted operations if the MG is deactivated.
>: Pre-MG is either activated or deactivated depending on BWP status or depending on whether the MG is affected MG or not.
>: Concurrent MG and NCSG are activated when configured. They can be deactivated depending on whether being affected MG or not.
>: Positioning MG is initially deactivated when configured. It is activated or deactivated based on a specific MAC CE. It is deactivated when it is being affected MG.

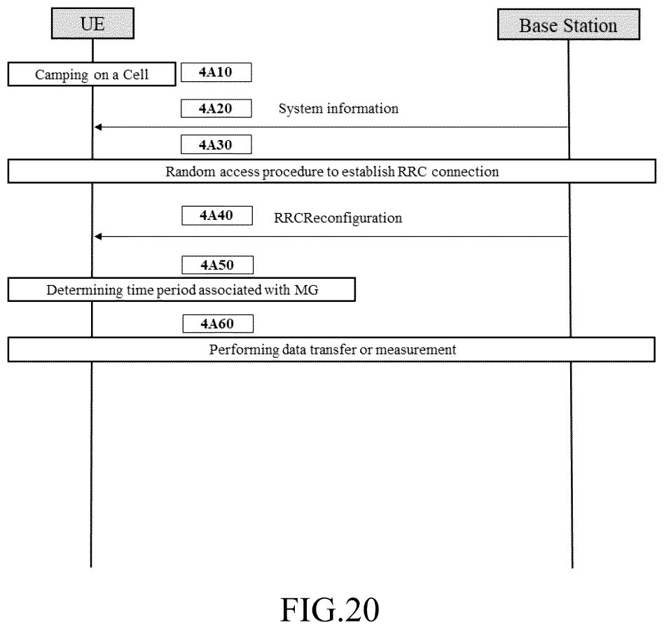

FIG. 20 is a diagram illustrating operations of the terminal and the base station for data transfer and measurement.

At 4A10, UE camps on a cell.

At 4A20, UE receives system information in the cell S1120.

At 4A30, UE performs in the cell random access procedure with GNB to establish RRC connection.

At 4A40, UE receives in the cell from GNB a RRCReconfiguration S1140. RRCReconfiguration includes MeasConfig IE and CellGroupConfig IE.

At 4A50, UE determines time period associated with MG based on MeasConfig.

At 4A60, UE performs data transfer or measurement.

In case that a specific DCI is received during a time period associated with a MG, tx/rx operation is performed in a specific set of serving cells during the MG. The specific DCI is DCI that schedules PDSCH or PUSCH in a serving cell that is associated with the MG. The specific set of serving cells are all serving cells that are associated with the MG.

In case that a specific SR is triggered during a time period associated with a MG, tx/rx operation is performed in a specific set of serving cells during the MG. The specific SR is SR that is triggered for a specific LCG/LCH The specific LCG/LCH is indicated in advance by RRC message. The specific set of serving cells are all serving cells that are associated with the MG.

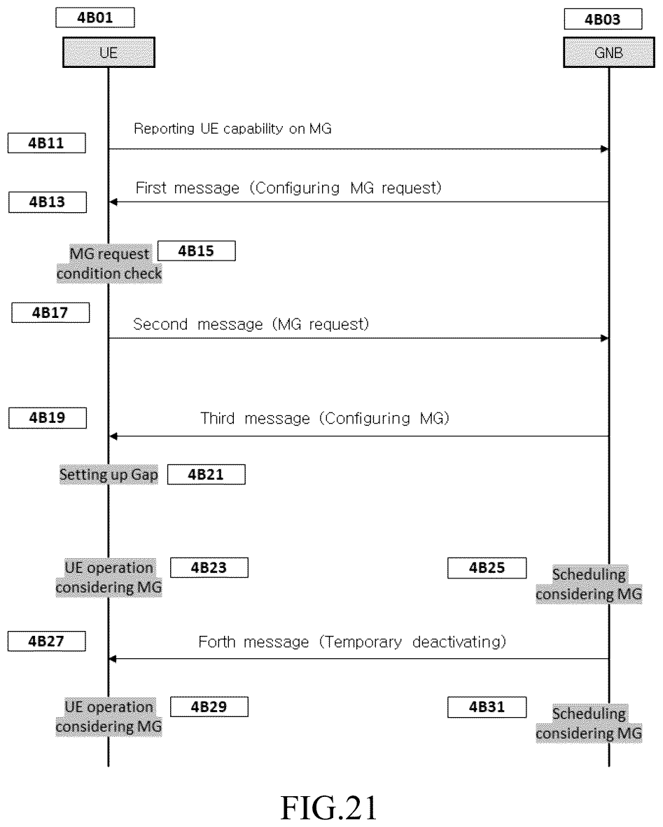

FIG. 21 is a diagram illustrating operations of the terminal and the base station for measurement gap.

UE and the base station may perform following.

At 4B11, UE transmits GNB UECapabilityInformation message.

UECapabilityInformation message includes following gap related capability information: gap-request-capability-information, gap-configuration-capability-information.

gap-request-capability-information includes following information: NeedForGap-Reporting, musim-NeedForGap-Reporting

UE can request Type1Gap and Type2Gap and Type3Gap and Type4Gap by transmitting either RRCReconfigurationComplete message or RRCResumeComplete message or LocationMeasurementInfo.

UE can request Type5Gap by transmitting UEAssistanceInformation.

For UE to request gap by transmitting RRCReconfigurationComplete or RRCResumeComplete or UEAssistanceInformation, GNB needs to configure UE to request gap. GNB determines it based on reported capability. UE can request gap by LocationMeasurementInfo without any prior configuration.

NeedForGap-Reporting indicates whether the UE supports reporting the measurement gap requirement information for NR target in the UE response to a network configuration RRC message. It is enumerated with a single value of “support”. It is per UE capability. A single IE can be present in UECapability for NR. Absence of the IE indicates the feature is not supported by the UE. Presence of the IE indicates the feature is supported by the UE in FR1 and in FR2 and in FDD and in TDD.

musim-NeedForGap-Reporting indicates whether the UE supports reporting the gap requirement information for MUSIM. It is enumerated with a single value of “support”. It is per UE capability. A single IE can be present in UECapability for NR. Absence of the IE indicates the feature is not supported by the UE. Presence of the IE indicates the feature is supported by the UE in FR1 and in FR2 and in FDD and in TDD.

NeedForGap-Reporting indicates the capability related to type1 Gap and type2Gap and type3Gap and type4Gap. If NeedForGap-Reporting and supportType2Gap are reported, UE supports reporting the measurement gap requirement information for Type2Gap. If NeedForGap-Reporting and supportType4Gap are reported, UE supports reporting the measurement gap requirement information for Type4Gap. If NeedForGap-Reporting is reported, UE supports reporting the measurement gap requirements for Type1Gap and Type3Gap.

UE does not report capability on whether the UE support reporting the measurement gap requirement information in the UE initiated RRC message (i.e., LocationMeasurementInfo).

gap-configuration-capability-information includes following information: supportedGapPattern, supportType2Gap, supportType4Gap, supportType5Gap, supportType6Gap and supportedGapCombination.

supportedGapPattern indicates measurement gap pattern(s) optionally supported by the UE. It is a bit string with 22 bits. The leading/leftmost bit (bit 0) corresponds to the gap pattern 2, the next bit corresponds to the gap pattern 3 and so on. A gap pattern is defined by a Gap Length and a Repetition Period. It is per UE capability. The supported gap patterns are supported by the UE in FR1 and in FR2 and in FDD and in TDD.

supportType2Gap indicates whether the UE supports Type2Gap (i.e., gap activated and deactivated depending on which BWP is activated; DL BWP dependent gap). It is per band capability. One or more IEs can be present in UECapability for NR. Absence of the IE in a band information indicates the feature is not supported by the UE in the corresponding band. Presence of the IE indicates the feature is supported by the UE in the corresponding band.

Alternatively, it can be per UE capability. In this case, a single IE can be present in UECapability for NR. Absence of the IE indicates the feature is not supported by the UE. Presence of the IE indicates the feature is supported by the UE in FR1 and in FDD and in TDD. To indicate whether UE supports Type2Gap in FR2, additional capability information is used.

supportType4Gap indicates whether the UE supports Type4Gap (i.e., gap consists of interruption period and measurement period; gap where interruption on data activity occurs in the beginning of a gap and in the end of a gap; gap where measurement is performed without interruption on data activity in the middle of the gap). It is per band capability. One or more IEs can be present in UECapability for NR. Absence of the IE in a band information indicates the feature is not supported by the UE in the corresponding band. Presence of the IE indicates the feature is supported by the UE in the corresponding band.

Alternatively, it can be per UE capability. In this case, a single IE can be present in UECapability for NR. Absence of the IE indicates the feature is not supported by the UE. Presence of the IE indicates the feature is supported by the UE in FR1 and in FR2 and in FDD and in TDD.

supportType5Gap indicates whether the UE supports Type5Gap. Alternatively, it indicates whether UE supports MUSIM assistance information reporting. It is per UE capability. A single IE can be present in UECapability for NR. Absence of the IE indicates the feature is not supported by the UE. Presence of the IE indicates the feature is supported by the UE in FR1 and in FR2 and in FDD and in TDD.

supportType6Gap indicates whether the UE supports Type6Gap. It is per FR capability. two IEs can be present in UECapability for NR. Absence of the IE for FR2 indicates the feature is not supported by the UE in the FR2. Presence of the IE for FR2 indicates the feature is supported by the UE in the FR and in TDD. Presence of the IE for FR1 indicates the feature is supported by the UE in the FR and in TDD and in FDD.

supportedGapCombination indicates gap combinations supported by the UE among predefined gap combinations. It is a bit string with a predefined size. The predefined size is equal to the number of predefined gap combinations optionally supported. The leading/leftmost bit (bit 0) corresponds to the optional gap combination with the lowest index, the next bit corresponds to the optional gap combination with the next lowest index and so on. A gap combination consists of gap combination identifier (or index) and number of per-FR1 gaps and number of per-FR2 gaps and number of per-UE gaps. This IE indicates the number of measurement gaps simultaneously supported by the UE. It is per UE capability. The supported gap combinations are supported by the UE in FR1 and in FR2 and in FDD and in TDD.

A gap combination consists of gap combination identifier (or index) and number of per-FR1 gaps and number of per-FR2 gaps and number of per-UE gaps. Among the predefined gap combinations, some predefined gap combinations are mandatorily supported by the UE. Some predefined gap combinations are optionally supported by the UE. supportedGapCombination indicates which optional gap combinations are supported by the UE.

Example is shown in the table below. The range of the integer is between 0 and 2 (i.e., the highest value is 2 and the lowest value is 0; the maximum number of simultaneous gaps per FR is 2).

TABLE 4

# of simultaneous MG

| Index | Per-FR1 | Per-FR2 | Per-UE |
|---|---|---|---|
| . . . | . . . | . . . | . . . |
| n | integer1 | integer2 | integer3 |
| n + 1 | integer4 | integer5 | integer6 |
| . . . | . . . | . . . | . . . |

Based on reported UE capabilities, GNB determines configurations to be applied to the UE.

bwp-SwitchingDelay defines whether the UE supports DCI and timer based active BWP switching delay type1 or type2. It indicates one of type1 and type2. It is per UE capability. The indicated bwp-SwitchingDelay is supported by the UE in FR1 and in FR2 and in FDD and in TDD.

At 4B13, GNB transmits UE first RRC message. first RRC message includes configuration information for gap request. Configuration information for gap request includes one of followings: needForGapsConfigNR, needForGapsConfigNR2, needForGapsConfigNR3, musim-AssistanceConfig and needFortype6GapConfig. needForGapsConfigNR and needForGapsConfigNR2 and needForGapsConfigNR3 can be included in RRCReconfiguration message or in RRCResume message. musim-AssistanceConfig and needForType6GapConfig can be included in otherConfig in RRCReconfiguration message.

needForGapsConfigNR contains configuration related to the reporting of measurement gap requirement information. needForGapsConfigNR includes a requestedTargetBandFilterNR. The requestedTargetBandFilterNR indicates the target NR bands that the UE is requested to report the gap requirement information. The requestedTargetBandFilterNR consists of one or more frequency band indicators.

needForGapsConfigNR2 indicates whether UE is allowed to provide NeedForGapsInfoNR2. This IE is enumerated with a single value “True”. If this IE is absent, UE is not allowed to provide NeedForGapsInfoNR2. If this IE is present, UE is allowed to provide NeedForGapsInfoNR2.

needForGapsConfigNR3 indicates whether UE is allowed to provide NeedForGapInfoNR3. This IE is enumerated with a single value “True”. If this IE is absent, UE is not allowed to provide NeedForGapInfoNR3. If this IE is present, UE is allowed to provide NeedForGapInfoNR3.

If RRCReconfiguration message or RRCResume message includes needForGapInfoNR or if needForGapInfoNR has been setup and has not been released, needForGapsConfigNR2 and needForGapInfoNR3 can be included in the RRCReconfiguration message or in the RRCResume message.

needForType6GapConfig indicates whether UE is configured to request for type6gap activation/deactivation and to provide preferred type6Gap pattern. This IE is enumerated with a single value “True”. If this IE is absent, UE is not configured to provide preferred type6Gap pattern (or preference on type6Gap). If this IE is present, UE is configured to provide preferred type6Gap pattern (or preference on type6Gap).

musim-AssistanceConfig includes a gapRequestProhibitTimer field. the gapRequestProhibitTimer is enumerated with values. Each value corresponds to length of duration in a unit of seconds.

At 4B15, UE checks whether gap-request is needed. UE generates gap request information if so.

UE considers itself to be configured to provide the measurement gap requirement information of NR target bands, if the RRCReconfiguration message includes the needForGapInfoNR and if needForGapInfoNR is set to setup.

UE considers itself to be configured to provide the measurement gap requirement information of NR target bands, if the RRCResume message includes the needForGapInfoNR and if needForGapInfoNR is set to setup.

condition-group-1 is fulfilled, if the RRCReconfiguration message was received via SRB1 but not within mrdc-SecondaryCellGroup or E-UTRA RRCConnectionReconfiguration or E-UTRA RRCConnectionResume, and if the UE is configured to provide the measurement gap requirement information of NR target bands, and if the RRCReconfiguration message includes the needForGapsConfigNR.

condition-group-2 is fulfilled if the RRCResume message includes the needForGapsConfigNR.

If condition-group-1 is fulfilled or condition-group-2 is fulfilled, UE includes the needForGapsInfoNR in the second RRC message and set the contents as follows:

UE includes intraFreq-needForGap and set the gap requirement information of intra-frequency measurement for each NR serving cell. UE sets either gap or no-gap for each serving cell.

UE includes an entry in interFreq-needForGap and set the gap requirement information for that band if requestedTargetBandFilterNR is configured, for each supported NR band that is also included in requestedTargetBandFilterNR. UE sets either gap or no-gap for each supported NR band.

If condition-group-1 is fulfilled and the RRCReconfiguration message includes needForGapsInfoNR2, or if condition-group-2 is fulfilled and the RRCResume message includes needForGapsInfoNR2, UE includes the needForGapsInfoNR2 in the second RRC message and set the contents as follows:

The second RRC message is RRCReconfigurationComplete if condition-group-1 was fulfilled. The second message is RRCResumeComplete if condition-group-2 was fulfilled.

UE includes intraFreq-needForGap2 and set the interruption requirement information (i.e., whether ncsg is required) of intra-frequency measurement for each NR serving cell. UE sets either ncsg or no-ncsg for each serving cell.

UE includes an entry in interFreq-needForGap2 and sets the interruption requirement information for that band if requestedTargetBandFilterNR is configured, for each supported NR band that is also included in requestedTargetBandFilterNR. UE sets either ncsg or no-nscg for each supported NR band.

If condition-group-1 is fulfilled and if the RRCReconfiguration message includes needForGapsInfoNR3 and if only one serving cell is configured to the UE (i.e., UE is not configured with carrier aggregation; UE is configured with single carrier) as consequence of reconfiguration, UE includes the needForGapsInfoNR3 in the second RRC message and set the contents as follows:

UE includes bwpNeedForGap and set the gap requirement information for each DL BWP of PCell (or SpCell).

If condition-group-2 is fulfilled and if the RRCResume message includes needForGapsInfoNR3 and if only one serving cell is configured to the UE (i.e., UE is not configured with carrier aggregation; UE is configured with single carrier) as consequence of RRC connection resumption, UE includes the needForGapsInfoNR3 in the second RRC message and set the contents as follows:

UE includes bwpNeedForGap and set the gap requirement information for each DL BWP of PCell (or SpCell).

UE considers itself to be configured to provide MUSIM assistance information, if the received otherConfig includes musim-AssistanceConfig and if musim-AssistanceConfig is set to setup.

If UE is configured to provide MUSIM assistance information and if UE needs the Type5Gap, UE initiate transmission of UEAssistanceInformation as follows:

If UE has a preference for Type5Gap, UE includes musim-GapRequestList in the UEAssistanceInformation.

If UE determines that type6Gap request is needed, UE generates a type6 request MAC CE. The type6 request MAC CE can include an information on ratio between the length of type6Gap and the repetition period of type6Gap. If transmission power sum should be decreased a lot, higher ratio is reported.

Alternatively, if UE is configured to provide its preference on type6Gap and if the UE did not transmit a UEAssistanceInformation with type6Gap-Preference since it was configured to provide its preference on type6Gap information, UE initiates transmission of UEAssistanceInformation.

If UE is configured to provide its preference on type6Gap and if the UE transmitted a UEAssistanceInformation with type6Gap-Preference since it was configured to provide its preference on type6Gap and if the current type6Gap preference is different from the one indicated in the last transmission of the UEAssistanceInformation, UE initiates transmission of UEAssistanceInformation.

If UE is configured to provide its preference on type6Gap and if the UE transmitted a UEAssistanceInformation with type6Gap-Preference since it was configured to provide its preference on type6Gap and if type6Gap is not required, UE initiates transmission of UEAssistanceInformation.

If transmission of the UEAssistanceInformation message is initiated to provide preference on type6Gap, UE includes Type6Gap-Preference IE in the UEAssistanceInformation.

If Type6Gap is required, UE includes a Type6Gap-bitmap in the Type6Gap-Preference IE.

If Type6Gap is not required, UE does not include a Type6Gap-bitmap in the Type6Gap-Preference IE.

UE transmits the UEAssistanceInformation to the base station.

NeedForGapsInfoNR consists of intraFreq-needForGap and interFreq-needForGap. NeedForGapsInfoNR is used to indicate the measurement gap requirement information of the UE for NR target bands.

intraFreq-needForGap field includes NeedForGapsIntraFreqlist IE. This field indicates the measurement gap requirement information for NR intra-frequency measurement.

NeedForGapsIntraFreqlist consists of one or more NeedForGapsIntraFreq. NeedForGapsIntraFreq consists of servCellId and gapIndicationIntra. servCellId indicates the serving cell which contains the target SSB (associated with the initial DL BWP) to be measured. gapIndicationIntra indicates whether measurement gap is required for the UE to perform intra-frequency SSB based measurements on the concerned serving cell. “gap” indicates that a measurement gap is needed if any of the UE configured BWPs do not contain the frequency domain resources of the SSB associated to the initial DL BWP. “no-gap” indicates a measurement gap is not needed to measure the SSB associated to the initial DL BWP for all configured BWPs.

interFreq-needForGap field includes NeedForGapsBandlistNR. This field indicates the measurement gap requirement information for NR inter-frequency measurement.

NeedForGapsBandlistNR consists of one or more NeedForGapsNR. NeedForGapsNR consists of bandNR and gapIndication. bandNR indicates the NR target band to be measured. gapIndication indicates whether measurement gap is required for the UE to perform SSB based measurements on the concerned NR target band while NR-DC or NE-DC is not configured. The UE determines this information based on the resultant configuration of the RRCReconfiguration or RRCResume message that triggers this response. Value gap indicates that a measurement gap is needed, value no-gap indicates a measurement gap is not needed.

NeedForGapsInfoNR2 consists of intraFreq-needForGap2 and interFreq-needForGap2. NeedForGapsInfoNR2 is used to indicate the interruption requirement information of the UE for NR target bands. Alternatively, this IE is used to indicate type4Gap (i.e., network controlled small gap) requirement information of the UE for NR target bands.

intraFreq-needForGap2 field includes one or more gapIndication2 IEs. Each of one or more gapIndication2 IE in intraFreq-needForGap2 indicates the interruption requirement (or type4Gap requirement) information for NR intra-frequency measurement with respect to a specific serving cell.

interFreq-needForGap2 field includes one or more gapIndication2 IEs. Each of one or more gapIndication2 IE in interFreq-needForGap2 indicates the interruption requirement (or type4Gap requirement) information for NR inter-frequency measurement with respect to a specific frequency band.

gapIndication2 is enumerated with three values: “gap” and “ncsg” and “nogap-noncsg”.

If gapIndication2 is set to “ncsg” for a serving cell, ncsg (or type4Gap) is required for the UE to perform intra-frequency SSB measurement on the concerned serving cell.

If gapIndication2 is set to “ncsg” for a frequency band, ncsg (or type4Gap) is required for the UE to perform SSB based measurement on the concerned target band.

If gapIndication2 is set to “gap” for a serving cell, type1Gap or type2Gap or type3Gap is required for the UE to perform intra-frequency SSB measurement on the concerned serving cell.

If gapIndication2 is set to “gap” for a frequency band, type1Gap or type2Gap or type3Gap is required for the UE to perform SSB based measurement on the concerned target band.

If gapIndication2 is set to “nogap-noncsg” for a serving cell, neither type1Gap nor type2Gap nor type3Gap nor type4Gap is required for the UE to perform intra-frequency SSB measurement on the concerned serving cell.

If gapIndication2 is set to “nogap-noncsg” for a frequency band, neither type1 Gap nor type2Gap nor type3Gap nor type4Gap is required for the UE to perform SSB based measurement on the concerned target band.

NeedForGapsInfoNR3 consists of a bwpNeedForGap. NeedForGapsInfoNR3 is used to indicate the measurement gap requirement information of DL BWPs configured for the UE.

bwpNeedForGap field includes a BIT STRING. The size of the BIT STRING is equal to the number of DL BWPs configured for the UE in the PCell. Alternatively, the size of the BIT STRING is fixed to a specific value such as 4.

The leading/leftmost bit (bit 0) corresponds to the DL BWP with lowest index (or BWP 0). The next bit corresponds to the DL BWP with next lowest index (or BWP 1) and so on. Value 1 indicates type2Gap is required for the UE to perform measurement in the corresponding DL BWP. Value 0 indicates type2Gap is not required for the UE to perform measurement in the corresponding DL BWP. The measurement can be intra-frequency measurement based on SSB or intra-frequency measurement based on CSI-RS.

musim-GapRequestList consists of MUSIM-GapRequestList IE. This IE indicate the MUSIM gap (i.e., type5Gap) requirement information.

MUSIM-GapRequestList IE includes one or two or three MUSIM-GapRequestInfo IE. The reason to limit to three in maximum is because configuring a single aperiodic gap and two periodic gaps is a common scenario with consideration of MUSIM gap usage.

MUSIM-GapRequestInfo includes RequestedMusim-GapType and RequestedMusim-GapOffset and RequestedMusim-GapLength and RequestedMusim-GapRepetitionPeriod and RequestedMusim-GapNumber.

RequestedMusim-GapType is enumerated with a single value of “aperiodic”. If this IE is present in MUSIM-GapRequestInfo and this IE indicates “aperiodic”, aperiodic musim-gap is required. If this IE is absent in MUSIM-GapRequestInfo, periodic musim-gap is required.

Alternatively, RequestedMusim-GapType is enumerated with a single value of “periodic”. If this IE is present in MUSIM-GapRequestInfo and this IE indicates “periodic”, periodic musim-gap is required. If this IE is absent in MUSIM-GapRequestInfo, aperiodic musim-gap is required.

Alternatively, if RequestedMusim-GapRepetitionPeriod is present in MUSIM-GapRequestInfo, periodic musim-gap is required. If this IE is absent in MUSIM-GapRequestInfo, aperiodic musim-gap is required.

Alternatively, if RequestedMusim-GapRepetitionPeriod in MUSIM-GapRequestInfo is set to a specific value like 0, aperiodic musim-gap is required. If RequestedMusim-GapRepetitionPeriod in MUSIM-GapRequestInfo is set to other value, periodic musim-gap is required.

Alternatively, if RequestedMusim-GapNumber is present in MUSIM-GapRequestInfo, aperiodic musim-gap is required. If this IE is absent in MUSIM-GapRequestInfo, periodic musim-gap is required.

RequestedMusim-GapOffset1 and RequestedMusim-GapOffset2 indicate the preferred musim-Gap starting time point.

RequestedMusim GapLength1 and RequestedMusim-GapLength2 indicate the preferred musim-Gap length.

RequestedMusim-GapRepetitionPeriod1 and RequestedMusim-GapRepetitionPeriod2 indicate the preferred repetition period.

RequestedMusim-GapNumber indicates the preferred number of aperiodic musim-Gap.

If the requested gap is periodic gap, RequestedMusim-GapOffset1 and RequestedMusim-GapLength1 and RequestedMusim-GapRepetitionPeriod1 are included.

If the requested gap is aperiodic gap, RequestedMusim-GapOffset2 and RequestedMusim-GapLength2 and RequestedMusim-GapRepetitionPeriod2 and RequestedMusim-GapNumber are included.

RequestedMusim-GapOffset1 is an integer between 0 and 159. RequestedMusim-GapOffset2 is an integer between 0 and 10239.

RequestedMusim-GapLength1 is enumerated with eight values: ms1dot5, ms3, ms3dot5, ms4, ms5dot5, ms6, ms10, ms20.

RequestedMusim-GapLength2 is enumerated with four values: ms32, ms64, ms128, ms256.

RequestedMusim-GapRepetitionPeriod1 is enumerated with four values: ms20, ms40, ms80, ms160.

RequestedMusim-GapRepetitionPeriod2 is enumerated with four values: ms64, ms128, ms256, ms512.

RequestedMusim-GapRepetitionPeriod1 is enumerated with four values: one, two, four, eight.

Type6Gap-Preference IE may include Type6Gap-bitmap IE or may include no sub-level IE.

The Type6Gap-bitmap is 4 bit. Each bit corresponds to a specific Type6Gap pattern. The first bit corresponds to a first Type6Gap pattern, the second bit corresponds to a second Type6Gap pattern and so on. Each of the first Type6Gap pattern and the second Type6Gap pattern and the third Type6Gap pattern is associated with a specific gap length and a specific gap repetition periodicity respectively.

The fourth Type6Gap pattern is associated with two gap lengths. The first gap length is applicable when the SCS of the active UL BWP of a first cell is 15 KHz or 30 KHz and the second gap length is applicable when the SCS of the active UL BWP of a first cell is 60 KHz or 120. The first cell is the SpCell of the UE. The first cell could be the serving cell with the shortest SCS among the configured serving cells in FR2. The first cell could be the serving cell with the longest SCS among the configured serving cells in FR2.

UE determines which type6Gap is required based on uplink transmission power situation and sets the corresponding bit accordingly.

At 4B17, UE transmits GNB second RRC message.

If the first RRC message was RRCResume message, the second RRC message is RRCResumeComplete message. The RRCResumeComplete message can include either NeedForGapsInfoNR or NeedForGapsInfoNR and NeedForGapsInfoNR2 or NeedForGapsInfoNR and NeedForGapsInfoNR3.

If the first RRC message was RRCReconfiguration message, and if UE considers itself to be configured to provide the measurement gap requirement information, the second RRC message is RRCReconfigurationComplete message. The RRCReconfigurationComplete message can include either NeedForGapsInfoNR or NeedForGapsInfoNR and NeedForGapsInfoNR2 or NeedForGapsInfoNR and NeedForGapsInfoNR3.

If the first RRC message was RRCReconfiguration message, and if UE consider itself to be configured to provide MUSIM assistance information or configured to provide its preference on type6Gap, the second RRC message is UEAssistanceInformation message.

The RRCReconfigurationComplete message includes same transaction-identifier as the transaction-identifier included in RRCReconfiguration message.

The RRCResumeComplete message includes same transaction-identifier as the transaction-identifier included in RRCResume message.

UEAssistanceInformation message does not include transaction-identifier.

GNB receives the second message and determines gap configurations for the UE.

At 4B19, GNB transmits UE third RRC message to indicate gap configuration.

The third message can be RRCReconfiguration message.

To configure Type1Gap or Type2Gap or Type3Gap or Type4Gap, GNB includes MeasConfig IE in the RRCReconfiguration message. The MeasConfig IE specifies measurements to be performed by the UE. The MeasConfig IE includes measGapConfig IE.

MeasGapConfig IE may include following fields: a gapFR2 field, a gapFR1 field, a gapUE field, a gapUEToAddModList field, a gapUEToReleaseList field, a gapFR1ToAddModList field, gapFR1ToReleaseList field, gapFR2ToReleaseList field and a gapFR2ToAddModList field

gapFR2 and gapFR1 and gapUE are defined as SetupRelease. If gapFR2 (or gapFR1 or gapUE) is set to “setup”, a gapConfig IE is included in the gapFR2 (or gapFR1 or gapUE) and a FR2-gap (or FR1-gap or UE-gap) is setup. If gapFR2 (or gapFR1 or gapUE) is set to “release”, corresponding gapConfig is released.

gapUEToReleaseList and gapFR1ToReleaseList and gapFR2ToReleaseList consist of one or more one or more MeasGapId IEs. gapUEToAddModList and gapFRIToAddModList and gapFR2ToAddModList consist of one or more GapConfig IEs. gapUE and gapFR1 and gapFR2 consist of a GapConfig IE.

gapUEToAddModList and gapUE configure one or more per-UE measurement gap. gapFR1ToAddModList and gapFR1 configure one or more per-FR1 measurement gap. gapFR2ToAddModList and gapFR2 configure one or more per-FR2 measurement gap.

During per-UE measurement gaps, UE does not conduct reception/transmission from/to the NR serving cells across FR1 and FR2 except the reception of signals used for RRM measurement(s), PRS measurement(s) and the signals used for random access procedure.

During per-FR1 measurement gaps, UE does not conduct reception/transmission from/to the FR1 NR serving cells except the reception of signals used for RRM measurement(s), PRS measurement(s) and the signals used for random access procedure.

During per-FR2 measurement gaps, UE does not conduct reception/transmission from/to the FR2 NR serving cells except the reception of signals used for RRM measurement(s), PRS measurement(s) and the signals used for random access procedure.

gapFR2 and gapFR1 and gapUE are used to configure a type1Gap. gapUEToAddModList and gapFR1ToAddModList and gapFR2ToAddModList are used to configure one or more type2Gap or type3Gap or type4Gap or combination of them.

gapFR2 is located in the non-extended part of the MeasGapConfig. gapFR1 and gapUE are located in the first extended part of the MeasGapConfig. gapUEToAddModList and gapFR1ToAddModList and gapFR2ToAddModList are located in the second extended part of the MeasGapConfig.

one or more one or more gapUEToAddModList one or more gapUEToAddModList gapUEToAddModList

A gapConfig IE indicates the time pattern of the gap and the type of the gap. A gapConfig IE includes measGapId and gapOffset and mgl and mgrp and mgta and mgl2 and type2Indicator and type4Indicator and deactivateIndicator

mgl2 is included in the second extended part of gapConfig IE. type2Indicator and type4Indicator and deactivateIndicator are included in the third extended part of gapConfig IE. The third extended part is placed after the second extended part in the gapConfig IE.

gapOffset indicates an integer between 0 and 159 (i.e., highest mgrp-1).

mgl is enumerated with six values: ms1dot5 and ms3 and ms3dot5 and ms4 and ms5dot5 and ms6. value ms1dot5 corresponds to 1.5 ms. value 3 ms corresponds to 3 ms and so on.

mgl2 is enumerated with two values: ms10 and ms20. mgl and mgl2 indicate the length of gap. If both mgl and mgl2 are included in a gapConfig, mgl2 is applied and mgl is ignored.

mgrp is enumerated with four values: ms20, ms40, ms80 and ms160.

mgta IE is enumerated with three values: ms0, ms0dot25 and ms0dot5. mgta IE indicates the measurement gap timing advance (or interruption timing advance in case of Type4Gap) in ms.

type4Indicator is enumerated with a single value of “True”. If this IE is present in the GapConfig, GapConfig is the configuration of type4Gap.

type2Indicator is enumerated with a single value of “True”. If this IE is present in the GapConfig, GapConfig is the configuration of type2Gap.

deactivateIndicator is enumerated with a single value of “Deactivated”. If this IE is present in the GapConfig, the gap is deactivated upon configuration. If this IE is absent in the GapConfig for type3Gap or for type4Gap, the gap is activated upon configuration. this IE is used only for type3Gap or type4Gap and not used for type2Gap.

If a GapConfig includes neither type4Indicator nor type2Indicator, GapConfig is the configuration of type3Gap.

A GapConfig does not include type2Indicator and deactivateIndicator at the same time. A GapConfig can include type4Indicator and deactivateIndicator at the same time.

measGapIdA measGapIdIE is an integer between 0 and 15. A measGapId identifies a measurement gap configuration of a type2Gap or a type3Gap or a type4Gap. Hence different measGapId is allocated across the types of measurement gaps and frequency regions of measurement gaps (i.e. a per-FR1 type3Gap and a per-FR2 type3Gap shall be allocated with different measGapId).

GapConfig IE included in gapFR2 field or in gapFR1 field or in gapUE field does not include measGapId IE. GapConfig IE included in gapUEToAddModList or gapFR1ToAddModList or gapFR2ToAddModList can include measGapId field.

To configure Type5Gap, GNB includes musim-GapConfig IE in the RRCReconfiguration message. musim-GapConfig IE indicates the gap configuration of Type5Gap that applies to all frequencies. a musim-GapConfig IE includes a single musim-GapToReleaseList IE and a single musim-GapToAddModList IE. A musim-GapToReleaseList consists of one or more musim-GapId. A musim-GapToAddModList consists of one or more musim-GapToAddMod IEs.

A musim-GapToAddMod IE can include musim-gapId, musim-Starting-SFN-AndSubframe, musim-GapLength and musim-GapRepetitionAndOffset.

A musim-gapId IE is an integer between 0 and 1.

musim-Starting-SFN-AndSubframe IE indicates the gap starting position for the aperiodic type5 gap. It includes starting SFN and starting subframe.

musim-GapRepetitionAndOffset indicates the gap repetition period in ms and gap offset in number of subframes. It includes an integer chosen from a integer set. The highest value of the integer set is equal to the repetition period-1. The integer indicates the starting offset of the gap. For example, a integer chosen from a integer set with highest value of 1279 indicates that the repetition period is 1280 ms. UE determines the offset based on the signaled integer and the repetition period based on the highest integer of the integer set.

If musim-gap is periodic gap, musim-GapLength and musim-GapRepetitionAndOffset are present.

If musim-gap is aperiodic gap, musim-Starting-SFN-AndSubframe is present.

To configure Type6Gap, GNB includes Type6GapConfig IE in the RRCReconfiguration message. Type6GapConfig IE indicates the gap configuration of Type6Gap that applies to a specific FR (i.e. FR2). Type6GapConfig IE includes a gapOffset field and a ugl field and a ugrp field.

ugl field indicates one of ms0dot125 and ms0dot25 and ms0dot5 and ms1. ms0dot125 corresponds to 0.125 ms, ms0dot25 corresponds to 0.25 ms and so on. ugl indicates a length of the type6 gap.

ugrp field indicates the gap repetition period of the type6 gap. ugrp field indicates one of ms5 and ms20 and ms40 and ms160.

type6GapRefServCellIndicator field indicates a serving cell identifier whose SFN and subframe is used for type6Gap calculation for gap pattern. If this field is absent, UE uses PCell for this purpose.

At 4B21, UE setup the gap based on the gap information received in 4B17.

If the third message includes measGapConfig IE, UE determines the gap to be setup according to the information included in the measGapConfig IE as shown in the table below.

TABLE 5

| | when the conditions are |
|---|---|
| | fulfilled, UE setup |
| Conditions for Type1Gap determination | following gap |
| If measGapConfig includes gapFR1 and if gapFR1 is set to | UE setup FR1 type1Gap |
| setup and if the GapConfig does not include the third | |
| extended part | |
| If measGapConfig includes gapFR1 and if gapFR1 is set to | UE release FR1 type1Gap |
| release and if the established gapFR1 is FR1 type1Gap | |
| If measGapConfig includes gapFR2 and if gapFR2 is set to | UE setup FR2 type1Gap |
| setup and if the GapConfig does not include the third | |
| extended part | |
| If measGapConfig includes gapFR2 and if gapFR2 is set to | UE release FR2 type1Gap |
| release and if the established gapFR2 is FR2 type1Gap | |
| If measGapConfig includes gapUE and if gapUE is set to | UE setup UE type1Gap |
| setup and if the GapConfig does not include the third | |
| extended part | |
| If measGapConfig includes gapUE and if gapFR2 is set to | UE release UE type1Gap |
| release and if the established gapUE is UE type1Gap | |

TABLE 6

| | when the conditions are |
|---|---|
| Conditions for Type2Gap determination | fulfilled |
| If measGapConfig includes a gapFR1ToAddModList and if | UE setup Per-FR1 type2Gap |
| type2Indicator is included (or set to TRUE) in at least one | for the corresponding |
| gapConfig in the list | measGapId |
| If measGapConfig includes gapFR1ToReleaseList and if at | UE release Per-FR1 |
| least one measGapId in the list is associated with Per-FR1 | type2Gap corresponding to |
| type2Gap | the measGapId |
| If measGapConfig includes a gapFR2ToAddModList and if | UE setup Per-FR2 type2Gap |
| type2Indicator is included (or set to TRUE) for at least one | for the corresponding |
| gapConfig in the list | measGapId |
| If measGapConfig includes gapFR2ToReleaseList and if at | UE release Per-FR2 |
| least one measGapId in the list is associated with Per-FR2 | type2Gap corresponding to |
| type2Gap | the measGapId |
| If measGapConfig includes a gapUEToAddModList and if | UE setup UE type2Gap for |
| type2Indicator is included (or set to TRUE) for at least one | the corresponding |
| gapConfig in the list | measGapId |
| If measGapConfig includes gapUEToReleaseList and if at | UE release UE type2Gap |
| least one measGapId in the list is associated with UE | corresponding to the |
| type2Gap | measGapId |

TABLE 7

| | when the conditions are |
|---|---|
| Conditions for Type3Gap determination | fulfilled |
| If measGapConfig includes a gapFR1ToAddModList and if | UE setup Per-FR1 type3Gap |
| neither type2Indicator nor type4Indicator are included in at | for the corresponding |
| least one gapConfig in the list | measGapId |
| If measGapConfig includes gapFR1ToReleaseList and if at | UE release Per-FR1 |
| least one measGapId in the list is associated with Per-FR1 | type3Gap corresponding to |
| type3Gap | the measGapId |
| If measGapConfig includes a gapFR2ToAddModList and if | UE setup Per-FR2 type3Gap |
| neither type2Indicator nor type4Indicator are included in at | for the corresponding |
| least one gapConfig in the list | measGapId |
| If measGapConfig includes gapFR2ToReleaseList and if at | UE release Per-FR2 |
| least one measGapId in the list is associated with Per-FR2 | type3Gap corresponding to |
| type3Gap | the measGapId |
| If measGapConfig includes a gapUEToAddModList and if | UE setup UE type3Gap for |
| neither type2Indicator nor type4Indicator are included in at | the corresponding |
| least one gapConfig in the list | measGapId |
| If measGapConfig includes gapUEToReleaseList and if at | UE release UE type3Gap |
| least one measGapId in the list is associated with UE | corresponding to the |
| type3Gap | measGapId |

TABLE 8

| | when the conditions are |
|---|---|
| Conditions for Type4Gap determination | fulfilled |
| If measGapConfig includes a gapFR1ToAddModList and if | UE setup Per-FR1 type4Gap |
| type4Indicator is included in at least one gapConfig in the list | for the corresponding |
| | measGapId |
| If measGapConfig includes gapFR1ToReleaseList and if at | UE release Per-FR1 |
| least one measGapId in the list is associated with Per-FR1 | type4Gap corresponding to |
| type4Gap | the measGapId |
| If measGapConfig includes a gapFR2ToAddModList and if | UE setup Per-FR2 type4Gap |
| type4Indicator is included in at least one gapConfig in the list | for the corresponding |
| | measGapId |
| If measGapConfig includes gapFR2ToReleaseList and if at | UE release Per-FR2 |
| least one measGapId in the list is associated with Per-FR2 | type4Gap corresponding to |
| type4Gap | the measGapId |
| If measGapConfig includes a gapUEToAddModList and if | UE setup UE type4Gap for |
| type4Indicator is included in at least one gapConfig in the list | the corresponding |
| | measGapId |
| If measGapConfig includes gapUEToReleaseList and if at | UE release UE type4Gap |
| least one measGapId in the list is associated with UE | corresponding to the |
| type4Gap | measGapId |

TABLE 9

| | when the conditions are |
|---|---|
| Conditions for Type5Gap determination | fulfilled |
| If musim-GapConfig includes musim-GapToAddModList | UE setup periodic UE |
| and if musim-GapLength and musim- | type5Gap for the |
| GapRepetitionAndOffset are included in at least one musim- | corresponding musim- |
| GapConfigToAddMod | gapId. |
| If musim-GapConfig includes musim-GapToAddModList | UE setup aperiodic UE |
| and if musim-Starting-SFN-AndSubframe is included in at | type5Gap for the |
| least one musim-GapConfigToAddMod | corresponding musim- |
| | gapId. |
| If musim-GapConfig includes musim-GapToReleaseList and | UE release UE type5Gap |
| if at least one musim-gapId is included in the list | corresponding to musim- |
| | gapId. |

TABLE 10

| | when the conditions are |
|---|---|
| Conditions for Type6Gap determination | fulfilled |
| If type6GapConfig is included in RRCReconfiguration and if | UE setup type6Gap |
| type6GapConfig is set to setup | |
| If type6GapConfig is included in RRCReconfiguration and if | UE release type6Gap |
| type6GapConfig is set to release | |

FR1 type1Gap and FR2 type1Gap and UE type1Gap and UE type2Gap and FR1 type3Gap and FR2 type3Gap and UE type3Gap and FR1 type4Gap and FR2 type4Gap and UE type4Gap are established as below.

UE setup the gap configuration indicated by the measGapConfig in accordance with OFFSET, i.e., the first subframe of each gap occurs at an SFN and subframe meeting the following condition:

$$SFN mod T = FLOOR ( OFFSET / 10 ) ;$$

$$subframe = gapOffset mod 10 ;$$

$$with T = mgrp / 10 ;$$

UE apply the specified timing advance mgta to the gap occurrences calculated above (i.e., the UE starts the measurement mgta ms before the gap subframe occurrences).

Periodic Type5Gap is established as below.

UE setup the gap configuration indicated by the musim-GapConfig in accordance with the received musim-GapRepetitionAndOffset-, i.e., the first subframe of each gap occurs at an SFN and subframe meeting the following condition:

$$SFN mod T = FLOOR ( INTEGER 1 - / 10 ) ;$$

$$subframe = gapOffset mod 10 ;$$

$$with T = MUSIM - PERIODICITY / 10 ;$$

INTEGER1 is the integer indicated by musim-GapRepetitionAndOffset. MUSIM-PERIODICITY is equal to the highest value of the corresponding integer set plus one. The corresponding integer set is the one where INTEGER1 is chosen.

Aperiodic Type5Gap is established as below.

UE setup the gap configuration indicated by the musim-GapConfig in accordance with musim-Starting-SFN-AndSubframe, i.e., the first subframe of the aperiodic gap occurs at an SFN and subframe indicated in musim-Starting-SFN-AndSubframe.

Type6Gap is established as below.

UE setup the gap configuration indicated by the type6GapConfig in accordance with the received gapOffset, i.e., the first subframe of each gap occurs at an SFN and subframe meeting the following condition:

$$SFN mod T = FLOOR ( gapOffset / 10 ) ;$$

subframe=gapOffset mod 10 if ugrp is larger than 5 ms;
subframe=gapOffset or gapOffset+5 ifugrp is equal to 5 ms;

$$with T = CEIL ( ugrp / 10 ) ;$$

Each gap occurs (or begins) at the first static uplink slot determined from the first subframe (i.e., each gap occurs/begins at the first static uplink slot starting from the first slot of the first subframe).

As a consequence of above operations, UE setup multiple gap configurations. To achieve reasonable level of UE implementation complexity, the possible combinations of gaps are limited as below.

TABLE 11

| | Simultaneous configuration & use (activation) |
|---|---|
| Case 1 | n1 * FR1-Type1Gap + n2 * FR2-Type1Gap can be configured and used |
| | simultaneously |
| | n1 and n2 are either 0 or 1. |
| Case 2 | n3 * UE-Type1Gap can be configured and used |
| | n3 is 1. |
| Case 3 | n1 * FR1-Type4Gap + n2 * FR2-Type4Gap can be configured and used |
| | simultaneously |
| Case 4 | n3 * UE-Type4Gap can be configured and used simultaneously |
| Case 5 | n4 * FR1-Type3Gap + n5 * FR2-Type3Gap + n6 * UE-Type3Gap can be |
| | configured and used simultaneously. |
| | n4 and n5 and n6 are either 0 or 1 or 2. |
| | All n4 and n5 and n6 being 0 is not valid |
| Case 6 | n7 * Type2Gap can be configured simultaneously |
| | n7 is either 1 or 2 or 3 |
| | Only one Type4Gap among the configured Type4Gap is used |
| Case 7 | n8* Type5Gap can be configured and used simultaneously |
| | n8 is 1 or 2 or 3 |

All the Type1Gap and Type3Gap and Type4Gap and Type5Gap are immediately used (i.e., used from the next occurrence) once the corresponding gap configurations are setup.

One or more Type2Gap configuration can be setup. However only subset of plurality of Type2Gap is used depending on the currently active downlink BWP.

Only one Type1Gap or only one Type4Gap can be configured and used as FR1-gap. one or two Type3Gap can be configured and used simultaneously as FR1-gap.

Only one Type1Gap or only one Type4Gap can be configured as FR2-gap. one or two Type3Gap can be configured and used simultaneously as FR2-gap.

Only one Type1Gap or only one Type4Gap can be configured and used simultaneously as UE-gap. One or more Type2Gap can be configured as UE-gap. One or more Type5Gap can be configured as UE-gap. Only one Type2Gap can be used as UE-gap. One or more Type5Gap can be used as UE-gap simultaneously.

A certain IE (or field) being enumerated with x and y means that the IE (or field) can indicate one of x and y.

At 4B23, UE applies gap operations during a gap. UE performs normal operations during non-gap.

TABLE 12

| Gap type | Applied gap operation |
|---|---|
| Type1Gap | Gap Operation 1 during the gap |
| Type2Gap | Gap Operation 1-1 during the gap |
| Type3Gap | Gap Operation 1-1 during the gap |
| Type4Gap | Gap Operation 2 during interruption length |
| | Gap operation 3 during measurement length |
| Type5Gap | Gap Operation 4 during the gap |
| Type6Gap | Gap Operation 6 during the gap |

A gap being active means the relevant gap operation being applied. A gap being inactive means the relevant gap operation not being applied and normal operation being applied as if gap is not configured.

Gap operation comprises data-activity-action-group and non-data-activity-action-group.

TABLE 13

| Gap operation type | data-activity-action-group | non-data-activity-action-group |
|---|---|---|
| Gap operation 1 | For serving-carrier-group, | performing SSB based |
| | not performing the | measurement on measurement- |
| | transmission of HARQ | object-group. |
| | feedback, SR, and CSI in | |
| | the uplink slots and in the | |
| | uplink symbols of | |
| | flexible slots during the | |
| | gap. | |
| | not reporting SRS in the | |
| | uplink slots and in the | |
| | uplink symbols of | |
| | flexible slots during the | |
| | gap. | |
| | not transmitting on UL- | |
| | SCH except for Msg3 or | |
| | the MSGA payload in the | |
| | uplink slots and in the | |
| | uplink symbols of | |
| | flexible slots during the | |
| | gap. | |
| | not monitoring the | |
| | PDCCH in the downlink | |
| | slots and in the downlink | |
| | symbols of flexible slots | |
| | during the gap except | |
| | period X. | |
| | not receiving on DL- | |
| | SCH in the downlink | |
| | slots and in the downlink | |
| | symbols of flexible slots | |
| | during the gap except | |
| | period X. | |
| | period X is when ra- | |
| | ResponseWindow or the ra- | |
| | ContentionResolutionTimer or | |
| | the msgB-Response Window is | |
| | running | |
| Gap operation 1-1 | same data-activity-action-group | performing SSB based |
| | as Gap operation 1 | measurement or CSI-RS based |
| | | measurement or PRS based |
| | | measurement on measurement- |
| | | object-group. |
| Gap operation 2 | same data-activity-action-group | RF retuning |
| | as Gap operation 1 | |
| Gap operation 3 | For serving-carrier-group, | same non-data-activity-action- |
| | performing the | group as Gap operation 1-1 |
| | transmission of HARQ | |
| | feedback, SR, and CSI in | |
| | the uplink slots and in the | |
| | uplink symbols of | |
| | flexible slots during the | |
| | gap. | |
| | reporting SRS in the | |
| | uplink slots and in the | |
| | uplink symbols of | |
| | flexible slots during the | |
| | gap. | |
| | transmitting on UL-SCH | |
| | in the uplink slots and in | |
| | the uplink symbols of | |
| | flexible slots during the | |
| | gap | |
| | monitoring the PDCCH | |
| | in the downlink slots and | |
| | in the downlink symbols | |
| | of flexible slots during | |
| | the gap. | |
| | receiving on DL-SCH in | |
| | the downlink slots and in | |
| | the downlink symbols of | |
| | flexible slots during the | |
| | gap. | |
| Gap operation 4 | same data-activity-action-group | performing paging |
| | as Gap operation 1 | reception or system |
| | | information reception for |
| | | the other USIM |
| Gap operation 6 | For serving-carrier-group (i.e. | |
| | FR2 serving cells), | |
| | not performing the | |
| | transmission of HARQ | |
| | feedback and CSI during | |
| | the gap. | |
| | not reporting SRS during | |
| | the gap. | |
| | not transmitting on UL- | |
| | SCH except for Msg3 or | |
| | the MSGA payload and | |
| | except for CG-PUSCH | |
| | during the gap. | |
| | performing transmission | |
| | on PUCCH allocation | |
| | for SR and on CG- | |
| | PUSCH resource and | |
| | PRACH resource | |

Type 1 gap and type 2 gap and type 3 gap and type 4 gap and type 5 gap consist with all types of slots (i.e. uplink slots and downlink slots and flexible slots indicated in tdd-UL-DL-ConfigurationCommon). A type 1 gap or a type 2 gap or a type 3 gap or a type 4 gap or a type 5 gap are consecutive in time within the respective gap (i.e. if the gap length is n ms, the distance between the starting point of the gap and the end point of gap is n ms) and consist with consecutive slots.

Type 6 gap consists with only static UL slots indicated in tdd-UL-DL-ConfigurationCommon. Type 6 gap could be non-consecutive in time (i.e. if the gap length is n ms, the distance between the starting point of the gap and the end point of gap could be longer than n ms) and consists with slots that could be non-consecutive with each other.

Time span of a gap is between the starting point of the gap and the end point of the gap.

During the time span of a type X gap (X is 1 or 2 or 3 or 4), UE is not required to (i.e. UE does not) conduct reception/transmission from/to the corresponding NR serving cells in the corresponding frequency range except the reception of signals used for RRM measurement(s) and the signals used for random access procedure.

During the time span of type 6 gap, UE is not required to (i.e. UE does not) conduct transmission to the corresponding NR serving cells in FR2 except for the signals used for random access procedure, CG-PUSCH (type 1 and 2) and PUCCH allocations for SR and LRR. During the time span of type 6 gap, UE conducts reception from the corresponding NR serving cell in FR2.

serving-carrier-group and measurement-object-group are determined as in table.

TABLE 14

| Gap Type | serving-carrier-group | measurement-object-group |
|---|---|---|
| Type1Gap | If the gap is FR2 gap, serving- | If the gap is FR2 gap, measurement- |
| | carrier-group is serving carriers (or | object-group is the measurement |
| | serving cells) on FR2. | objects configured for FR2 |
| | If the gap is FR1 gap, serving- | frequencies. |
| | carrier-group is serving carriers (or | If the gap is FR1 gap, measurement- |
| | serving cells) on FR1. | object-group is the measurement |
| | If the gap is UE gap, serving-carrier- | objects configured for FR1 |
| | group is all serving carriers (or | frequencies. |
| | serving cells) or serving carriers (or | If the gap is UE gap, measurement- |
| | serving cells) on FR1 and FR2. | object-group is the measurement |
| | | objects configured for FR1 |
| | | frequencies and FR2 frequencies. |
| Type2Gap | Same as Type1Gap | Same as Type1Gap |
| Type3Gap | Same as Type1Gap | Regardless of whether the gap is |
| | | FR1 gap or FR2 gap or UE gap, |
| | | measurement-object-group is |
| | | determined based on the associated |
| | | measurement objects. |
| | | If the gap is FR2 gap, only the |
| | | measurement objects on FR2 can be |
| | | associated with the gap. |
| | | If the gap is FR1 gap, only the |
| | | measurement objects on FR1 can be |
| | | associated with the gap. |
| Type4Gap | Same as Type1Gap | Same as Type1Gap |
| Type5Gap | Type5Gap is UE gap. | Type5Gap is UE gap. |
| | serving-carrier-group is all serving | measurement-object-group is the |
| | carriers (or serving cells) or serving | measurement objects configured for |
| | carriers (or serving cells) on FR1 | FR1 frequencies and FR2 |
| | and FR2. | frequencies. |
| Type6Gap | Type6Gap is FR2 gap | N/A (UE is not required to perform |
| | | measurement) |

At 4B25, GNB performs transmission and reception with the UE considering the configured gap.

At 4B27, GNB transmits a fourth message to temporary deactivate the measurement gap. The fourth message is either a MAC CE or a DCI.

At 4B29, UE applies gap operations during a first gap. UE performs normal operations during a second gap and during non-gap. The first gap is activated gap that is not deactivated by the fourth message. The second gap is activated gap before the reception of the fourth message which is deactivated by the fourth message.

At 4B31, GNB performs transmission and reception with the UE considering the deactivated gap.

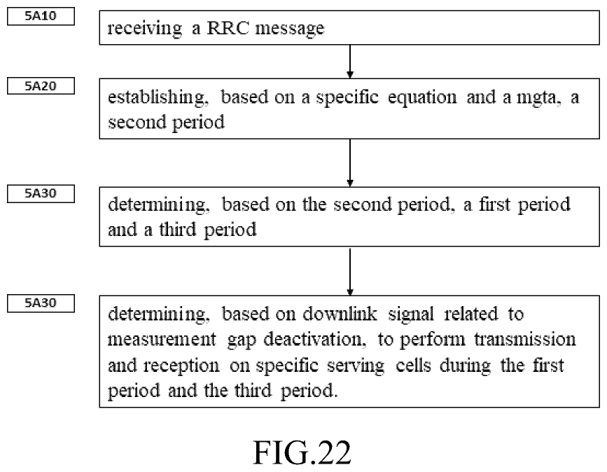

FIG. 22 is a diagram illustrating operations of the terminal.

UE performs followings.

At 5A10, UE receives from a base station, a RRCReconfiguration that includes MeasConfig and CellGroupConfig.

At 5A20, UE establishes, based on a specific equation and a mgta, a second period.

At 5A30, UE determines, based on the second period, a first period and a third period.

At 5A40, UE determines, based on downlink signal related to measurement gap deactivation, whether to perform transmission and reception on specific serving cells during the first period and the third period.

DCI format 0_0 is used for the scheduling of PUSCH in one cell. The following information is transmitted by means of the DCI format 0_0 with CRC scrambled by C-RNTI or CS-RNTI or MCS-C-RNTI:

Identifier for DCI formats; Frequency domain resource assignment; Time domain resource assignment; Frequency hopping flag; Modulation and coding scheme; New data indicator; Redundancy version; HARQ process number; TPC command for scheduled PUSCH etc.

DCI format 0_1 is used for the scheduling of one or multiple PUSCH in one cell. The following information is transmitted by means of the DCI format 0_1:

Identifier for DCI formats; Carrier indicator; Bandwidth part indicator; Frequency domain resource assignment; Time domain resource assignment; Frequency hopping flag; Modulation and coding scheme; New data indicator; Redundancy version; HARQ process number; TPC command for scheduled PUSCH etc.

DCI format 0_2 is used for the scheduling of PUSCH in one cell. The following information is transmitted by means of the DCI format 0_2:

Identifier for DCI formats; Carrier indicator; Bandwidth part indicator; Frequency domain resource assignment; Time domain resource assignment; Frequency hopping flag; Modulation and coding scheme; New data indicator; Redundancy version; HARQ process number; TPC command for scheduled PUSCH etc.

DCI format 1_0 is used for the scheduling of PDSCH in one DL cell. The following information is transmitted by means of the DCI format 1_0:

Identifier for DCI formats; Carrier indicator; Bandwidth part indicator; Frequency domain resource assignment; Time domain resource assignment; Frequency hopping flag; Modulation and coding scheme; New data indicator; Redundancy version; HARQ process number; Downlink assignment index; TPC command for scheduled PUCCH etc.

DCI format 1_1 is used for the scheduling of one or multiple PDSCH in one cell. The following information is transmitted by means of the DCI format 1_1:

Identifier for DCI formats; Carrier indicator; Bandwidth part indicator; Frequency domain resource assignment; Time domain resource assignment; Frequency hopping flag; Modulation and coding scheme; New data indicator; Redundancy version; HARQ process number; Downlink assignment index; TPC command for scheduled PUCCH etc.

DCI format 1_2 is used for the scheduling of PDSCH in one cell. The following information is transmitted by means of the DCI format 1_2:

Identifier for DCI formats; Carrier indicator; Bandwidth part indicator; Frequency domain resource assignment; Time domain resource assignment; Frequency hopping flag; Modulation and coding scheme; New data indicator; Redundancy version; HARQ process number; Downlink assignment index; TPC command for scheduled PUCCH etc.

When the UE is scheduled to transmit a transport block and no CSI report by a DCI or by a RAR UL grant or fallbackRAR UL grant, or the UE is scheduled to transmit a transport block and a CSI report(s) on PUSCH by a DCI, the ‘Time domain resource assignment’ field value m for the scheduled PUSCH on the serving cell of the DCI or the PUSCH time resource allocation field value m of the RAR UL grant or of the fallbackRAR UL grant provides a row index m+1 to a resource allocation table.

The indexed row defines the slot offset K₂, the start and length indicator SLIV, or directly the start symbol S and the allocation length L, the PUSCH mapping type, the number of slots used for TBS determination (if numberOfSlotsTBoMS is present in the resource allocation table), and the number of repetitions (if numberOfRepetitions is present in the resource allocation table) to be applied in the PUSCH transmission.

When the UE is scheduled to receive PDSCH by a DCI, the Time domain resource assignment field value m for the scheduled PDSCH on the serving cell provides a row index m+1 to a resource allocation table. The indexed row defines the slot offset K₀, the start and length indicator SLIV, or directly the start symbol S and the allocation length L, and the PDSCH mapping type to be assumed in the PDSCH reception.

The number of consecutive symbols L counting from the starting symbol S allocated for the PDSCH are determined from the start and length indicator SLIV:
if (L−1) is equal to or smaller than 7, SLIV=14*(L−1)+S;
if (L−1) is greater than 7, SLIV=14*(14−L+1)+ (14−1−S);
wherein L is greater than 0 and equal to or smaller than 14−S.

The IE PDSCH-TimeDomainResourceAllocation is used to configure a time domain relation between PDCCH and PDSCH. The PDSCH-TimeDomainResourceAllocationList contains one or more of such PDSCH-TimeDomainResourceAllocations. The network indicates in the DL assignment which of the configured time domain allocations the UE shall apply for that DL assignment. The UE determines the bit width of the DCI field based on the number of entries in the PDSCH-TimeDomainResourceAllocationList. Value 0 in the DCI field refers to the first element in this list, value 1 in the DCI field refers to the second element in this list, and so on.

```
  -- ASN1START
  -- TAG-PDSCH-TIMEDOMAINRESOURCEALLOCATIONLIST-START
```

| | |
|---|---|
| PDSCH-TimeDomainResourceAllocationList ::= | SEQUENCE |

(SIZE(1..maxNrofDL-Allocations)) OF PDSCH-TimeDomainResourceAllocation
PDSCH-TimeDomainResourceAllocation ::= SEQUENCE {

| | |
|---|---|
| k0 | INTEGER(0..32) |

OPTIONAL, -- Need S

| | |
|---|---|
| mappingType | ENUMERATED {typeA, |

typeB},

| | |
|---|---|
| startSymbolAndLength | INTEGER (0..127) |

}

| | |
|---|---|
| PDSCH-TimeDomainResourceAllocationList-r16 ::= | SEQUENCE |

(SIZE(1..maxNrofDL-Allocations)) OF PDSCH-TimeDomainResourceAllocation-r16
PDSCH-TimeDomainResourceAllocation-r16 ::= SEQUENCE {

| | |
|---|---|
| k0-r16 | INTEGER(0..32) |

OPTIONAL, -- Need S

| | |
|---|---|
| mappingType-r16 | ENUMERATED {typeA, |

typeB},

| | |
|---|---|
| startSymbolAndLength-r16 | INTEGER (0..127), |
| repetitionNumber-r16 | ENUMERATED {n2, n3, n4, |

```
n5, n6, n7, n8, n16} OPTIONAL, -- Cond Formats1-0_1-1_4-0_4-1_4-2
    ...,
    [[
```

| | |
|---|---|
| k0-v1710 | INTEGER(33..128) |

```
OPTIONAL -- Need S
    ]],
    [[
```

| | |
|---|---|
| repetitionNumber-v1730 | ENUMERATED {n2, n3, n4, n5, |
| n6, n7, n8, n16} | OPTIONAL -- Cond Format1-2 |

```
    ]]
  }
```

| | |
|---|---|
| Dummy-TDRA-List ::= | SEQUENCE (SIZE(1..maxNrofDL-Allocations)) OF |

MultiPDSCH-TDRA-r17

| | |
|---|---|
| MultiPDSCH-TDRA-List-r17 ::= | SEQUENCE (SIZE(1.. maxNrofDL- |

AllocationsExt-r17)) OF MultiPDSCH-TDRA-r17
MultiPDSCH-TDRA-r17 ::= SEQUENCE {

| | |
|---|---|
| pdsch-TDRA-List-r17 | SEQUENCE |

```
(SIZE(1..maxNrofMultiplePDSCHs-r17)) OF PDSCH-TimeDomainResourceAllocation-r16,
    ...
  }
  -- TAG-PDSCH-TIMEDOMAINRESOURCEALLOCATIONLIST-STOP
  -- ASN1STOP
```

k0 field indicates slot offset between DCI and its scheduled PDSCH

repetitionNumber indicates the number of PDSCH transmission occasions for slot-based repetition scheme in IE RepetitionSchemeConfig. The parameter is used as specified in 38.214 [19].

startSymbolAndLength indicates an index giving valid combinations of start symbol and length (jointly encoded) as start and length indicator (SLIV).

The IE PUSCH-TimeDomainResourceAllocation is used to configure a time domain relation between PDCCH and PUSCH. PUSCH-TimeDomainResourceAllocationList contains one or more of such PUSCH-TimeDomainResourceAllocations. The network indicates in the UL grant which of the configured time domain allocations the UE shall apply for that UL grant. The UE determines the bit width of the DCI field based on the number of entries in the PUSCH-TimeDomainResourceAllocationList. Value 0 in the DCI field refers to the first element in this list, value 1 in the DCI field refers to the second element in this list, and so on.

```
  -- ASN1START
  -- TAG-PUSCH-TIMEDOMAINRESOURCEALLOCATIONLIST-START
```

| | |
|---|---|
| PUSCH-TimeDomainResourceAllocationList ::= | SEQUENCE |

(SIZE(1..maxNrofUL-Allocations)) OF PUSCH-TimeDomainResourceAllocation
PUSCH-TimeDomainResourceAllocation ::= SEQUENCE {

| | |
|---|---|
| k2 | INTEGER(0..32) |

OPTIONAL, -- Need S

| | |
|---|---|
| mappingType | ENUMERATED {typeA, |

typeB},

| | |
|---|---|
| startSymbolAndLength | INTEGER (0..127) |

}

| | |
|---|---|
| PUSCH-TimeDomainResourceAllocationList-r16 ::= | SEQUENCE |

(SIZE(1..maxNrofUL-Allocations-r16)) OF PUSCH-TimeDomainResourceAllocation-r16
PUSCH-TimeDomainResourceAllocation-r16 ::= SEQUENCE {

| | |
|---|---|
| k2-r16 | INTEGER(0..32) |

OPTIONAL, -- Need S

| | |
|---|---|
| puschAllocationList-r16 | SEQUENCE |

```
(SIZE(1..maxNrofMultiplePUSCHs-r16)) OF PUSCH-Allocation-r16,
  ...
  }
  PUSCH-Allocation-r16 ::= SEQUENCE {
```

| | |
|---|---|
| mappingType-r16 | ENUMERATED {typeA, |
| typeB} | OPTIONAL, -- Cond NotFormat01-02-Or-TypeA |
| startSymbolAndLength-r16 | INTEGER (0..127) |

OPTIONAL, -- Cond NotFormat01-02-Or-TypeA

| | |
|---|---|
| startSymbol-r16 | INTEGER (0..13) |

OPTIONAL, --Cond RepTypeB

| | |
|---|---|
| length-r16 | INTEGER (1..14) |

OPTIONAL, -- Cond RepTypeB

| | |
|---|---|
| numberOfRepetitions-r16 | ENUMERATED {n1, n2, n3, |

```
n4, n7, n8, n12, n16} OPTIONAL, -- Cond Format01-02
    ...,
    [[
```

| | |
|---|---|
| numberOfRepetitionsExt-r17 | ENUMERATED {n1, n2, n3, |

n4, n7, n8, n12, n16, n20, n24, n28, n32, spare4, spare3, spare2,

spare 1}

OPTIONAL, --Cond Format01-02-For-TypeA

| | |
|---|---|
| numberOfSlotsTBoMS-r17 | ENUMERATED {n1, n2, n4, |

n8, spare4, spare3, spare2, spare1} OPTIONAL, -- Need R

| | |
|---|---|
| extendedK2-r17 | INTEGER (0..128) |

```
OPTIONAL --Cond MoldPUSCH
    ]]
  }
  -- TAG-PUSCH-TIMEDOMAINRESOURCEALLOCATIONLIST-STOP
  -- ASN1STOP
```

field indicates the length allocated for PUSCH for DCI format 0_1/0_2

startSymbol indicates the index of start symbol for PUSCH for DCI format 0_1/0_2. startSymbolAndLength indicates an index giving valid combinations of start symbol and length (jointly encoded) as start and length indicator (SLIV).

numberOfRepetitions field indicates number of repetitions for DCI format 0_1/0_2.

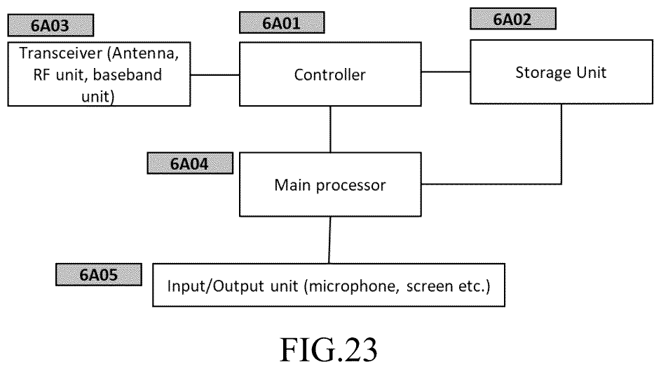

FIG. 23 is a block diagram illustrating the internal structure of a UE to which the disclosure is applied.

Referring to the diagram, the terminal includes a controller (6A01), a storage unit (6A02), a transceiver (6A03), a main processor (6A04) and I/O unit (6A05).

The controller (6A01) controls the overall operations of the terminal in terms of mobile communication. For example, the controller (6A01) receives/transmits signals through the transceiver (6A03). In addition, the controller (6A01) records and reads data in the storage unit (6A02). To this end, the controller (6A01) includes at least one processor. For example, the controller (6A01) may include a communication processor (CP) that performs control for communication and an application processor (AP) that controls the upper layer, such as an application program. The controller controls storage unit and transceiver such that UE operations illustrated in this disclosure are performed.

The storage unit (6A02) stores data for operation of the terminal, such as a basic program, an application program, and configuration information. The storage unit (6A02) provides stored data at a request of the controller (6A01).

The transceiver (6A03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (6A04) controls the overall operations other than mobile operation. The main processor (6A04) process user input received from I/O unit (6A05), stores data in the storage unit (6A02), controls the controller (6A01) for required mobile communication operations and forward user data to I/O unit (6A05).

I/O unit (6A05) consists of equipment for inputting user data and for outputting user data such as a microphone and a screen. I/O unit (6A05) performs inputting and outputting user data based on the main processor's instruction.

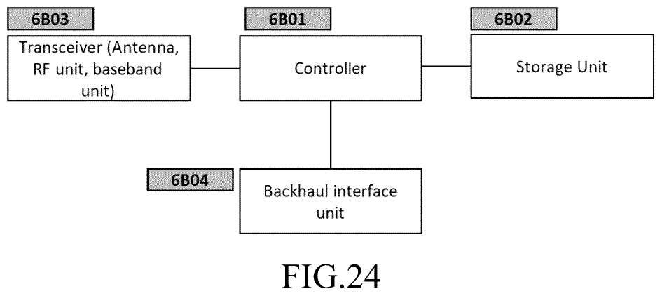

FIG. 24 is a block diagram illustrating the configuration of a base station according to the disclosure.

As illustrated in the diagram, the base station includes a controller (6B01), a storage unit (6B02), a transceiver (6B03) and a backhaul interface unit (6B04).

The controller (6B01) controls the overall operations of the main base station. For example, the controller (6B01) receives/transmits signals through the transceiver (6B03), or through the backhaul interface unit (6B04). In addition, the controller (6B01) records and reads data in the storage unit (6B02). To this end, the controller (6B01) may include at least one processor. The controller controls transceiver, storage unit and backhaul interface such that base station operation illustrated in FIG. 2A are performed.

The storage unit (6B02) stores data for operation of the main base station, such as a basic program, an application program, and configuration information. Particularly, the storage unit (6B02) may store information regarding a bearer allocated to an accessed UE, a measurement result reported from the accessed UE, and the like. In addition, the storage unit (6B02) may store information serving as a criterion to determine whether to provide the terminal with multi-connection or to discontinue the same. In addition, the storage unit (6B02) provides stored data at a request of the controller (6B01).

The transceiver (6B03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (6B04) provides an interface for communicating with other nodes inside the network. The backhaul interface unit (6B04) converts a bit string transmitted from the base station to another node, for example, another base station or a core network, into a physical signal, and converts a physical signal received from the other node into a bit string.

Below lists acronym used in the present disclosure.

| | | | |
|---|---|---|---|
| 5GC | 5G Core Network | RACH | Random Access Channel |
| ACK | Acknowledgement | RAN | Radio Access Network |
| AM | Acknowledged Mode | RAR | Random Access Response |
| AMF | Access and Mobility Management Function | | |
| RA-RNTI | Random Access RNTI | | |
| ARQ | Automatic Repeat Request | RAT | Radio Access Technology |
| AS | Access Stratum | RB | Radio Bearer |
| ASN.1 | Abstract Syntax Notation One | RLC | Radio Link Control |
| BSR | Buffer Status Report | RNA | RAN-based Notification Area |
| BWP | Bandwidth Part | RNAU | RAN-based Notification Area Update |
| CA | Carrier Aggregation | RNTI | Radio Network Temporary Identifier |
| CAG | Closed Access Group | RRC | Radio Resource Control |
| CG | Cell Group | RRM | Radio Resource Management |
| C-RNTI | Cell RNTI | RSRP | Reference Signal Received Power |
| CSI | Channel State Information | RSRQ | Reference Signal Received Quality |
| DCI | Downlink Control Information | RSSI | Received Signal Strength Indicator |
| DRB | (user) Data Radio Bearer | SCell | Secondary Cell |
| DTX | Discontinuous Reception | SCS | Subcarrier Spacing |
| HARQ | Hybrid Automatic Repeat Request | | |
| SDAP | Service Data Adaptation Protocol | | |
| IE | Information element | SDU | Service Data Unit |
| LCG | Logical Channel Group | SFN | System Frame Number |
| MAC | Medium Access Control | S-GW | Serving Gateway |
| MIB | Master Information Block | SI | System Information |
| NAS | Non-Access Stratum | SIB | System Information Block |
| NG-RAN | NG Radio Access Network | SpCell | Special Cell |
| NR | NR Radio Access | SRB | Signalling Radio Bearer |
| PBR | Prioritised Bit Rate | SRS | Sounding Reference Signal |
| PCell | Primary Cell | SS | Search Space |
| PCI | Physical Cell Identifier | SSB | SS/PBCH block |
| PDCCH | Physical Downlink Control Channel | | |
| SSS | Secondary Synchronisation Signal | | |
| PDCP | Packet Data Convergence Protocol | SUL | Supplementary Uplink |
| PDSCH | Physical Downlink Shared Channel | | |
| TM | Transparent Mode | | |
| PDU | Protocol Data Unit | UCI | Uplink Control Information |
| PHR | Power Headroom Report | UE | User Equipment |
| PLMN | Public Land Mobile Network | UM | Unacknowledged Mode |
| PRACH | Physical Random Access Channel | | |
| CRP | Cell Reselection Priority | | |
| PRB | Physical Resource Block | PSS | Primary Synchronisation Signal |
| PUCCH | Physical Uplink Control Channel | | |
| PUSCH | Physical Uplink Shared Channel | | |

What is claimed is:

1. A method by a terminal, the method comprising:
receiving from a base station a RRCReconfiguration message, wherein the RRCReconfiguration message comprises one or more sets of parameters for measurement gap configuration and a parameter related to temporary deactivation of measurement gap;
performing, during a set of measurement gaps and for a specific set of serving cells, a first set of operations;
receiving from the base station a specific downlink control information (DCI) that comprises a field related to temporary deactivation of measurement gap;
performing, during a specific measurement gap and for the specific set of serving cells, a second set of operations in case that the field is set to a first value; and
performing, during a second set of measurement gaps and for the specific set of serving cells, the first set of operations,
wherein:
time distance between the specific measurement gap and the specific DCI is determined based on an offset; and
the offset is configured in the RRCReconfiguration message, and
wherein the set of measurement gaps, the specific measurement gap and the second set of measurement gaps are configured based on a same set of parameters for measurement gap configuration.

2. The method of claim 1,
wherein the same set of parameters for measurement gap configuration comprises:
a first parameter indicating length of the measurement gap;
a second parameter indicating periodicity of the measurement gap; and
a third parameter related to the specific set of serving cells.

3. The method of claim 2,
wherein the second parameter determines:
time distance between adjacent measurement gaps of the set of measurement gaps; and
time distance between adjacent measurement gaps of the second set of measurement gaps.

4. The method of claim 2,
wherein the specific set of serving cells are determined based on the third parameter.

5. The method of claim 1,
wherein the terminal performs, during the specific measurement gap and for the specific set of serving cells, the first set of operations in case that the field is set to a second value.

6. The method of claim 1,
wherein the first set of operations comprises:
preamble transmission; and
first specific physical uplink shared channel transmission.

7. The method of claim 6,
wherein the second set of operations comprises:
reference signal transmission; and
second specific physical uplink shared channel transmission.

8. The method of claim 7, wherein:
the second set of operations further comprises transmission of scheduling request; and
the scheduling request is associated with a specific uplink traffic.

9. The method of claim 1, wherein:
the first value is associated with a specific period;
the specific period is determined based on the offset and a length; and
the offset and the length are configured by the RRCReconfiguration message.

10. A terminal comprising:
a transceiver,
a memory, and
a controller coupled to the transceiver and the memory, wherein the controller is configured to cause the terminal to:
receive from a base station a RRCReconfiguration message, wherein the RRCReconfiguration message comprises one or more sets of parameters for measurement gap configuration and a parameter related to temporary deactivation of measurement gap,
perform, during a set of measurement gaps and for a specific set of serving cells, a first set of operations,
receive from the base station a specific downlink control information (DCI) that comprises a field related to temporary deactivation of measurement gap,
perform, during a specific measurement gap and for the specific set of serving cells, a second set of operations in case that the field is set to a first value, and
perform, during a second set of measurement gaps and for the specific set of serving cells, the first set of operations,
wherein:
time distance between the specific measurement gap and the specific DCI is determined based on an offset; and
the offset is configured in the RRCReconfiguration message, and
wherein the set of measurement gaps, the specific measurement gap and the second set of measurement gaps are configured based on a same set of parameters for measurement gap configuration.
